(19) United States
(12) Patent Application Publication
(10) Pub. No.: US 2015/0024149 A1
(43) Pub. Date: Jan. 22, 2015

(54) POLARIZING PLATE, METHOD FOR MANUFACTURING POLARIZING PLATE AND LIQUID CRYSTAL DISPLAY DEVICE

(71) Applicant: Konica Minolta, Inc., Tokyo (JP)

(72) Inventors: Yasuhiro Watanabe, Hachioji-shi (JP); Kentaro Yano, Kobe-shi (JP)

(21) Appl. No.: 14/375,267

(22) PCT Filed: Jan. 18, 2013
(86) PCT No.: PCT/JP2013/050970

§ 371 Date: Jul. 29, 2014

(30) Foreign Application Priority Data
Jan. 30, 2012 (JP) 2012-016074

(51) Int. Cl. G02B 1/04; G02F 1/1335; G02B 1/10

(52) U.S. Cl. CPC G02B 1/04; G02B 1/105; G02F 1/133528
USPC 428/1.31; 428/216; 156/231

(57) ABSTRACT

The polarizing plate has a high contrast and little image inconsistency (corner inconsistency) as well as curl stability and durability under a high-temperature and high-humidity environment. The polarizing plate is a laminate of a substrate with a hard coat layer and a polarizer. The polarizer is formed by applying a stretching process after laminating a hydrophilic polymer layer on which a dichroic material is absorded, onto a thermoplastic resin layer by a coating technique. The thickness of the hydrophilic polymer layer is within the range of 0.5 to 10 μm and the thickness of the hard coat layer is within the range of 1.0 to 5.0 μm. The substrate having the hard coat layer satisfies a condition prescribed by the following formula (1): Formula (1): 3<T<18, where T (N/10 mm)=(tensile strength)×(rupture elongation)^{1/2}.

### TECHNICAL FIELD

The present invention relates to a polarizing plate, a method for manufacturing a polarizing plate, and a liquid crystal display device.

### BACKGROUND ART

Thin display market utilizing liquid crystal displays and organic electroluminescent devices has been rapidly expanded in recent years. In particular, the expansion of the market of small-to-medium-sized mobile devices, such as smartphones and iPads is noticeable.

Requirements for the small-to-medium-sized mobile devices are improvements in contrast in displayed image and reductions in thickness and weight. A major challenge is therefore a low-profile configuration of the individual components included in the displays.

One solution to the problem is reductions in the thicknesses of polarizers and substrates, which are main components. To meet the solution, a disclosed method for making a polarizing plate involves applying a hydrophilic polymer onto a substrate, stretching the substrate and dyeing the polymer (for example, refer to Patent Document 1). According to the method disclosed in Patent Document 1, the resulting polarizer has a thickness of 10 μm or less, compared to traditional polarizers having a thickness exceeding 20 μm.

In production of polarizing plates, any other transparent substrate should be bonded thereto to protect the surface of the polarizers. Since substrates used in polarizing plates typically have a thickness in the range of 60 to 100 μm, mere thinning of polarizers cannot significantly contribute to thinning of overall polarizing plates under present circumstances.

Mere thinning of substrates causes other problems including frequent ruptures of films during a process of bonding to polarizers and a process of bonding the resulting polarizing plates to panels and ruptures or damage to the films during a transfer process in the production line.

A possible measure for reducing ruptures and damage to a substrate film is formation of a hard coat layer having high frictional resistance on the surface of the substrate. Unfortunately, application of this layer to a thin polarizing plate causes undesirable color unevenness due to degradation over time after the plate is curled or rolled.

In small-to-medium-sized liquid crystal displays or organic electroluminescent displays provided with touch panels, polarizing plates are directly bonded to the touch panels or back light members in many cases. This achieves a high contrast without interfacial reflection on the surface of the polarizing plate, a low profile, and an improved strength of the overall product. In order to dissipate heat from the back light and the exterior to the polarizing plate more effectively, thinner polarizing plates having higher environmental resistance are eagerly anticipated.

### PRIOR ART DOCUMENTS

### Patent Documents

Patent Document 1: Japanese Patent Application Laid Open Publication No. 2011-100161

### DISCLOSURE OF THE INVENTION

### Problems to be Solved by the Invention

An object of the present invention, which has been accomplished to solve the problems described above, is to provide a thin polarizing plate having high contrast with reduced image unevenness (also referred to as corner irregularity), high stability in a curled state, and high resistance to high-temperature and high-humid environments, a method for manufacturing the polarizing plate, and a liquid crystal display device including the polarizing plate.

### Means for Solving the Problem

The present inventor, who has conducted extensive study to solve the problems described above, has found that a thin polarizing plate satisfying the following conditions has high contrast with reduced image unevenness (also referred to as corner irregularity), high stability in a curled state, and high resistance to high-temperature and high-humid environments and has completed the invention. The polarizing plate includes a laminate of a substrate having a hard coat layer formed by an application process and a polarizer comprising a hydrophilic polymer layer on which a dichroic substance is adsorbed, wherein the polarizer is formed by applying the hydrophilic polymer layer onto a thermoplastic resin layer and stretching the layers, the stretched hydrophilic polymer layer and the hard coat layer each have a predetermined range of thickness, and the substrate having the hard coat layer has a predetermined range of toughness T represented by {tensile strength (N/10 mm)}×(elongation at break)^{1/2}.

The solution to the problems described above can be achieved by the following means.

1. A polarizing plate comprising a laminate of a substrate which has a hard coat layer formed by an application process and a polarizer which includes a hydrophilic polymer layer on which a dichroic substance is adsorbed, wherein the polarizer is formed by applying the hydrophilic polymer layer onto a thermoplastic resin layer and stretching the layers, the stretched hydrophilic polymer layer has a thickness in range of 0.5 to 10 μm, the hard coat layer has a thickness in range of 1.0 to 5.0 μm, and the substrate having the hard coat layer satisfies a condition defined by Expression (1):

3<T<18 Expression (1)

where T (N/10 mm)=A×(B)1/2, A is a tensile strength (N/10 mm) determined in accordance with JIS K 7127, and B is an elongation at break determined in accordance with JIS K 7127.
2. The polarizing plate of claim 1, wherein the substrate has a thickness in range of 5.0 to 25 μm.
3. The polarizing plate of claim 1 or 2, wherein the substrate includes a cellulose ester film.
4. The polarizing plate of any one of claims 1 to 3, wherein the thermoplastic resin layer includes a cellulose ester film or a polyethylene terephthalate film.
5. The polarizing plate of any one of claims 1 to 4, wherein the substrate contains an ester compound being a reaction product of phthalic acid, adipic acid, benzenemonocarboxylic acid and an alkylene glycol having a carbon number of 2 to 12.
6. The polarizing plate of any one of claims 1 to 5, wherein the hydrophilic polymer layer of the polarizer includes a coat of a polyviniyl alcohol resin.
7. The polarizing plate of any one of claims 1 to 6, wherein the dichroic substance includes an iodine-containing compound.
8. A method for manufacturing the polarizing plate set forth in any one of claims 1 to 7, the method comprising: applying a hydrophilic polymer coating solution onto a thermoplastic resin layer to form a hydrophilic polymer layer; stretching a laminate of the thermoplastic resin layer and the hydrophilic polymer layer in a longitudinal or lateral direction to produce a polarizer including the hydrophilic polymer layer; bonding the laminate to a substrate; and removing the thermoplastic resin layer.
9. A liquid crystal display device comprising the polarizing plate set forth in any one of claims 1 to 7.

It is presumed that the configuration defined in the present invention can solve the problems for the following reason.

The elements, the tensile strength (N/10 mm) and the elongation at break, of the T value defined by the present invention are typical mechanical characteristics of a substrate provided with a hard coat layer relative to external stress applied thereto.

Polarizers (hydrophilic polymer layers) produced by conventional processes have a large thickness, and resins, for example, hydrophilic polymers of the polarizers have high contractive force in thermal or humid environments. Substrates must also have rigidity not causing strain due to contractive stress. As a result, conventional substrates with hard coat layers must have a high T value defined by Expression (1) exceeding 18.

In the polarizing plate including a thin polarizer of the present invention, the resin of the polarizer has small contractive force, whereas a thick substrate having a high T value generates strain due to differential deformation and differential shrinkage at the interface between the polarizer and the substrate. In particular, a thin-film polarizer has a polarization region at a significantly limited surface of the resin forming the polarizer, and slight strain at the interface in a conventional thick polarizer thus affects the degree of polarization and color unevenness in a display element.

The present invention is characterized in that the substrate provided with the hard coat layer moves on the deformation of the resin of the polarizer to reduce the strain due to stress. This characteristic structure contributes to a thin polarizing plate that can maintain a high degree of uniform polarization, high curling stability, and high resistance to high-temperature and high-humidity environments.

### Effects of the Invention

The means of the present invention provides a thin polarizing plate having high contrast with reduced image unevenness (corner irregularity), high stability in a curled state, and high resistance to high-temperature and high-humid environments, a method for manufacturing the polarizing plate, and a liquid crystal display device including the polarizing plate.

### BRIEF DESCRIPTION OF DRAWINGS

FIG. 1 This is a schematic view of a tenter used in the stretching step of a polarizer of the present invention.

### EMBODIMENTS FOR CARRYING OUT THE INVENTION

A polarizing plate of the present invention is a laminate of a substrate having a hard coat layer formed by an application process and a polarizer consisting of a hydrophilic polymer on which a dichroic substance is adsorbed. The polarizer is formed by applying the hydrophilic polymer layer onto a thermoplastic resin layer and stretching the layers. The stretched hydrophilic polymer layer has a thickness in the range of 0.5 to 10 μm, while the hard coat layer has a thickness in the range of 1.0 to 5.0 μm. The substrate having the hard coat layer has a toughness T in the range of 3 to 18, wherein T is represented by {tensile strength (N/10 mm)}×(elongation at break)^{1/2}. Such a thin polarizing plate has high contrast with reduced image unevenness (corner irregularity), high stability in a curled state, and high resistance to high-temperature and high-humid environments. These features are common between the inventions set forth in claims 1 to 9.

In a preferred embodiment of the present invention, the substrate should have a thickness in the range of 5.0 to 25 μm in view of an effective achievement of the advantages of the present invention. The substrate should preferably be a cellulose ester film. The thermoplastic resin layer should preferably be a cellulose ester film or polyethylene terephthalate film. The substrate should preferably include polyester compounds. The hydrophilic polymer layer of the polarizer should preferably be formed by applying a polyvinyl alcohol resin. The dichroic substance should preferably be an iodine-containing compound.

A method for making a polarizing plate of the present invention is characterized in that the polarizer consisting of a hydrophilic polymer layer is produced through applying a hydrophilic polymer coating solution onto a thermoplastic resin layer to form a hydrophilic polymer layer; stretching the laminate of the thermoplastic resin layer and the hydrophilic polymer layer in a longitudinal or lateral direction; bonding the laminate to the substrate; and removing the thermoplastic resin layer.

The present invention and the components thereof, and embodiments to carry out the present invention will now be described in detail. As used in the following description, the term “to” indicating a numerical range is meant to encompass the values on both sides thereof as a lower limit and upper limit.

<<Polarizing Plate>>

The polarizing plate of the present invention is a laminate of a substrate having a hard coat layer formed by an application process, in more specific, by a wet application process, and a hydrophilic polymer layer on which a dichroic substance is adsorbed. A hydrophilic polymer is applied onto a thermoplastic resin layer to form the hydrophilic polymer layer, and the laminate of the thermoplastic resin layer and the hydrophilic polymer layer is stretched to form a polarizer.

The substrate of the polarizing plate, the thermoplastic resin layer and hydrophilic polymer layer of the polarizer will now be described.

[Substrate]

The substrate (hereinafter also referred to as a “substrate film” or “protective film”) according to the present invention include a hard coat layer having a thickness in the range of 1.0 to 5.0 μm. The substrate including the hard coat layer has a toughness T in the range of 3 to 18, wherein T is represented by {tensile strength (N/10 mm)}×(elongation at break)^{1/2}.

As described above, one of the features of the polarizing plate according to the present invention is the hydrophilic polymer layer (polarizer) formed by an application process and having a thickness in the range of 0.5 to 10 μm. A conventional polarizing plate including a thin polarizer and a thick substrate having a high T value generates strain due to differential deformation and differential shrinkage at the interface between the polarizer and the substrate. In particular, a thin-film polarizer has a polarization region at a significantly limited surface; thus slight strain at the interface in a conventional thick polarizer affects the degree of polarization and color unevenness in a display element as a final product.

The present invention, which have been made in view of the above circumstances, is characterized by the application of the substrate of the polarizing plate, the substrate having a toughness T in the range of 3 to 18, wherein T is represented by {tensile strength (N/10 mm)}×(elongation at break)^{1/2}.

A substrate having a toughness T above 3 can provide a sufficient mechanical strength. Application of a substrate having a T value below 18 to a thin polarizer can provide a polarizing plate that can prevent a strain due to differential deformation and differential shrinkage and has reduced image unevenness (corner irregularity), high stability in a curled state, and high resistance to high-temperature and high-humid environments.

The T value of the substrate having the hard coat layer according to the present invention can be determined as follows.

The substrate (substrate film) on which the hard coat layer is applied was conditioned under an environment of 23° C. and a relative humidity of 55%, and was then cut into a width of 10 mm and a length of 130 mm. The substrate is subjected to a tensile test which stretches the substrate in the direction (TD) orthogonal to a film-transferring direction and in a transferring direction (MD) with a tensile tester, Tensilon RTC-1225 (available from Orientic Corporation Inc.) in accordance with JIS K 7127, under the conditions of a chuck distance of 50 mm and a rate of stretching of 100 mm/min, to determine a tensile strength (N/10 mm) and elongation at break. The tensile strength and elongation at break shown in the present invention is based on an average value of a value in TD and that in MD.

The determined tensile strength (N/10 mm) and elongation at break are applied to the following expression to determine a T value by the following expression.

T value (N/10 mm)=tensile strength×(elongation at break)^{1/2}.

For the substrate having a hard coat layer according to the present invention, a preferred tensile strength to determine a T values should preferably be in the range of 10 to 100N for 10 mm, more preferably, 15 to 80 N for 10 mm, and most preferably 20 to 50N for 10 mm.

For the substrate having a hard coat layer according to the present invention, a preferred elongation at break to determine a T value should be in the range of 0.01 to 0.50, and more preferably, 0.02 to 0.20.

Any means can be used to control the T value of the substrate having the hard coat layer included in the polarizing plate of the present invention. Such a control can be achieved by appropriately regulating the thickness of the substrate, a type of resin material and additive forming the substrate, a draw ratio of the substrate film, the material or the thickness of the hard coat layer, for example. In a preferred embodiment to fully exhibit the technical feature of the present invention, the substrate having the hard coat layer should be stretched into a thin film having a thickness in the range of 5.0 to 25 μm, which range is unknown in the art. Alternatively, the substrate should be formed of a cellulose ester resin on which polyester compounds, in the form of additives, are applied.

[Material for Substrate]

Preferred materials for the substrate of the present invention have various excellent properties such as transparency, mechanical strength, thermal stability, moisture blocking, isotropy, and ductility. Examples of such material include, but not limited to, cellulose resins, such as triacetyl cellulose; polyester resins, such as polyethylene terephthalate and polyethylene naphthalate; polyether sulfone resins; polysulfone resins; polycarbonate resins; polyamide resins, such as nylons and aromatic polyamides; polyimide resins, polyolefin resins, such as polyethylene, polypropylene, and ethylene-propylene copolymers; cyclic polyolefin resins having a cyclic and norbornene structure (norbornene resins); (meth)acrylic resins; polyarylate resins; polystyrene resins; poly(vinyl alcohol) resins; and mixtures thereof. Among these materials, cellulose resins (cellulose esters) are preferred as materials for the substrate.

(Cellulose Ester)

The cellulose ester forming the substrate of the present invention preferably is a cellulose triacetate having a degree of acetyl substitution within the range of 2.80 to 2.95 and a number average molecular weight in the range of 125000 to 155000.

It is preferred that the substrate is composed of cellulose triacetate A having a degree of acetyl substitution within the range of 2.80 to 2.95 and number average molecular weight in the range of 125000 to 155000 and cellulose triacetate B having a degree of acetyl substitution within the range of 2.75 to 2.90 and a number average molecular weight within the range of 155500 to 180000.

The degree of acetyl substitution can be determined in accordance with ASTM-D817-96.

The cellulose triacetate A has a degree of an acetyl substitution in the range of preferably 2.80 to 2.95, more preferably 2.84 to 2.94. The number average molecular weight (Mn) ranges preferably from 125000 to 155000, more preferably 129000 to 152000. The weight average molecular weight (Mw) ranges preferably from 265000 to 310000. The ratio Mw/Mn is preferably in the range of 1.9 to 2.1.

The cellulose triacetate B has a degree of acetyl substitution in the range of preferably 2.75 to 2.90, more preferably 2.79 to 2.89. Mn ranges preferably from 155500 to 180000, more preferably from 156000 to 175000. Mw ranges preferably from 290000 to 360000. The ratio Mw/Mn is preferably within the range of 1.8 to 2.0.

The weight ratio of the cellulose triacetate A to the cellulose triacetate B preferably ranges from 100:0 to 20:80 in the present invention.

The average molecular weights (Mn and Mw) and the molecular weight distribution of the cellulose triacetate used for the substrate of the present invention can be determined by gel permeation chromatography. Typical conditions for measurement will be described below.

Solvent: methylene chloride
Column: serially connected Shodex K806, K805, and K803G (made by Showa Denko K.K.)

### Column Temperature: 25° C.

Concentration of sample: 0.1 mass %
Detector: RI Model 504 (made by GL Science)
Pump: L6000 (made by Hitachi Ltd.)
Flow rate: 1.0 ml/min
Calibration curve: based on 13 STK standard polystyrene samples (made by Tosoh Corporation) having Mw of 2,800,000 to 500. Preferably 13 samples have substantially equal difference in molecular weight.

The cellulose ester of the present invention can be synthesized with reference to the procedures disclosed in Japanese Patent Application Laid Open Publication Nos. H10-45804 and 2005-281645.

With trace amounts of metal components in the cellulose ester, the iron (Fe) component is preferably 1 ppm or less. The calcium (Ca) component is 60 ppm or less, preferably 0 to 30 ppm. Magnesium (Mg) component is preferably 0 to 70 ppm, more preferably 0 to 20 ppm. The metal contents, such as iron (Fe), calcium (Ca), and magnesium (Mg) can be determined by inductively coupled plasma-atomic emission spectrometry (ICP-AES) using a completely dried cellulose ester that is preliminarily treated in a microdigest wet decomposition unit (nitric acid decomposition) and then by alkaline fusion.

The cellulose triacetate in the present invention may contain a third cellulose ester such as cellulose acetate propionate in an amount (10 mass % or less) that can maintain the performance of the present invention.

In a preferred embodiment, the cellulose ester contains cellulose having grafted substituent groups in an amount of 2 to 20% of the overall cellulose ester or cellulose diacetate such that the average degree of substitution in the overall cellulose ester is in the range of 2.75 to 2.85 to achieve high retardation and to prevent brittle degradation of the stretched film.

Preferred cellulose having grafted substituent groups are cellulose esters having a repeating unit represented by General Formula (1) or (2):

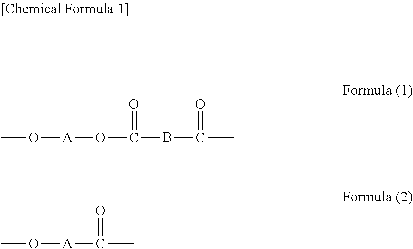

Examples of A are as follows:

### A-1: —CH₂CH₂—

### A-2: —CH₂CH₂CH₂—

### A-3: —CH═CH—

### A-4:

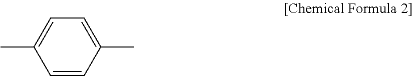

### A-5:

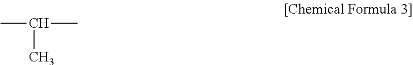

### A-6: —CH₂C(CH₃)₂—

Examples of B are as follows:

### B-1: —CH₂CH₂—

### B-2: —CH₂CH₂CH₂CH₂—

### B-3:

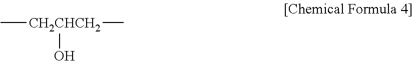

### B-4:

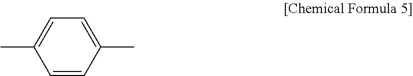

The cellulose ester having the repeating unit represented by General Formula (1) or (2) can be prepared by esterification of a polybasic acid or its anhydride with a polyvalent alcohol, ring-opening polymerization of L-lactide or D-lactide, or self condensation of L-lactic acid or D-lactic acid, in the presence of cellulose having unsubstituted hydroxy groups or cellulose ester of which parts of hydroxyl groups are replaced with acyl groups, such as an acetyl, propionyl, butyryl, or phthalyl groups.

Examples of polybasic acid anhydride used in the esterification reaction include, but not limited to, maleic anhydride, phthalic anhydride, and fumaric anhydride.

Examples of polyvalent alcohol used in the esterification reaction include, but not limited to, glycerin, ethylene glycol, and propylene glycol.

Although the esterification reaction can proceed in the absence of catalyst, any Lewis acid catalyst may be used. Examples of usable catalyst include metals, such as tin, zinc, titanium, bismuth, zirconium, germanium, antimony, sodium potassium, and aluminum; and derivatives thereof. Preferred examples of the derivative include metal-organic compounds, carbonates, oxides, and halides. Specific examples include octyltin, tin chloride, zinc chloride, titanium chloride, alkoxytitanium, germanium oxide, zirconium oxide, antimony trioxide, and alkylaluminum. Acid catalysts such as p-toluensulfonic acid can also be used as catalysts. Known compounds, such as carbodiimide and dimethylaminopyridine may also be added to facilitate the dehydration reaction between carboxylic acid and alcohol.

The esterification reaction may be carried out in an organic solvent that can dissolve the cellulose ester and compounds involved in the reaction, in a batch kneader capable of agitation with heat under sharing force, or in a uniaxial or biaxial extruder.

The content of the repeating unit in the present invention may range from 0.5 to 190 mass % to the corresponding cellulose.

The cellulose ester may have any degree of substitution, and preferably ranges from 2.2 to 3.0 in view of thermoplasticity and hot processability.

If the cellulose ester of the present invention is aliphatic ester, examples of the acyl group to be esterified with a hydrogen atom at an hydroxy group in the cellulose molecule include C₂ to C₂₀ acyl groups, such as acetyl, propionyl, butyryl, isobutyryl, valeryl, pivaloyl, hexanoyl, octanoyl, lauroyl, and stearoyl.

The number average molecular weight of the repeating unit ranges from 300 to 10000, preferably from 500 to 8000 to the corresponding cellulose in view of hot processability. The number average molecular weight of the repeating unit in the corresponding cellulose ester was determined through comparison of the unesterified cellulose with the esterified cellulose based on the polystyrene equivalent GPC molecular weight or ¹H-NMR data (JNM-EX-270 made by JEOL, solvent: deuteromethylene chloride).

During the incorporation of the repeating unit in the cellulose molecule, oligomer or polyester having the repeating unit represented by General Formula (1) or (2) may be formed by side reaction. Since these compounds function as plasticizer, these may remain in the cellulose ester product without purification.

The content of the repeating unit to the cellulose ester is 30 mass % or less, which does not significantly affect the properties of the cellulose ester. The content preferably ranges from 0.5 to 20 mass % in view of plasticity.

The number average molecular weight of the oligomer and polyester ranges from 300 to 10000, preferably 500 to 8000 in view of plasticity.

(Additives for Substrate)

Additives will now be described that can be compounded in the cellulose ester film being the substrate of the present invention.

<Ester Compound>

The substrate of the present invention preferably contains ester compounds that are reaction products of phthalic acid, adipic acid, and benzenemonocarboxylic acid with C₂ to C₁₂ alkylene glycol.

The ester compounds of the present invention are ester plasticizers, in particular aromatic-terminated ester plasticizer.

Examples of benzenemonocarboxylic acid component in the ester compound of the present invention include benzoic acid, p-tert-butylbenzoic acid, o-toluic acid, m-toluic acid, para-toluic acid, dimethylbenzoic acid, ethylbenzoic acid, n-propylbenzoic acid, aminobenzoic acid, and acetoxybenzoic acid. These may be used alone or in combination. Benzoic acid is most preferred.

Examples of C₂-C₁₂ alkylene glycol components include ethylene glycol, 1,2-propylene glycol, 1,3-propylene glycol, 1,2-butanediol, 1,3-butanediol, 1,2-propanediol, 2-methyl-1,3-propanediol, 1,4-butanediol, 1,5-pentanediol, 2,2-dimethyl-1,3-propanediol (neopentyl glycol), 2,2-diethyl-1,3-propanediol(3,3-dimethylolpentane), 2-n-butyl-2-ethyl-1,3propanediol (3,3-dimethylolheptane), 3-methyl-1,5-pentanediol, 1,6-hexanediol, 2,2,4-trimethyl-1,3-pentanediol, 2-ethyl1,3-hexanediol, 2-methyl1,8-octanediol, 1,9-nonanediol, 1,10-decanediol, and 1,12-octadecanediol. These glycol components may be used alone or in combination. Particularly preferred is 1,2-propylene glycol.

The ester compound of the present invention has adipate group and phthalate group in the final compound. Acid anhydrides or esters of these acids may be used for production of the ester compound.

The ester plasticizer used in the present invention has a number average molecular weight in the range of preferably 300 to 1500, more preferably 400 to 1000, and an acid value of 1.5 mgKOH/g or less, and a hydroxy value of 25 mgKOH/g or less. More preferably, the acid value is 0.5 mgKOH/g or less, and the hydroxy value is 15 mgKOH/g or less.

The ester compound of the present invention can be synthesized with reference to the descriptions disclosed in, for example, Japanese Patent Application Laid Open Publication Nos. 2008-69225, 2008-88292, and 2008-115221. A preferred ester compound in the present invention has both the adipate group and the phthalate group and can be synthesized in the presence of adipic acid and phthalic acid as dicarboxylic acid components.

The ester compound of the present invention is a mixture of synthetic esters having different molecular weights and different molecular structures, and preferably contains at least one ester compound having a phthalate group and an adipate group in its structure.

The substrate containing the ester compound of the present invention is superior to a mixture of an ester compound from adipic acid and an ester compound from phthalic acid as a dicarboxylic acid component.

The substrate preferably contains the ester compound in an amount of 1 to 35 mass %, in particular 5 to 30 mass %, which range does not cause bleeding out.

<Acrylic Copolymer>

The substrate (cellulose ester film) of the present invention may contain an acrylic polymer having a weight average molecular weight in the range of 500 to 30000. In particular, the substrate preferably contains a copolymer X of an ethylenically unsaturated monomer Xa having no aromatic ring or hydrophilic group and an ethylenically unsaturated monomer Xb having a hydrophilic group but not an aromatic ring, the copolymer having a weight average molecular weight in the range of 5000 to 30000, more preferably contains a mixture of a copolymer X of an ethylenically unsaturated monomer Xa having no aromatic ring or hydrophilic group and an ethylenically unsaturated monomer Xb having a hydrophilic group but not an aromatic ring, the copolymer having a weight average molecular weight in the range of 5000 to 30000, and a polymer Y of an ethylenically unsaturated monomer Ya having no aromatic ring, the polymer having a weight average molecular weight in the range of 500 to 3000.

These acrylic copolymers can be compounded in an amount of 1 to 30 mass % to the cellulose ester.

<Compound Having Furanose or Pyranose Structure>

The substrate of the present invention may contain a compound having 1 to 12 furanose or pyranose structures in which parts or all of the OH groups in the furanose or pyranose structures are esterified (hereinafter, also referred to as sugar ester compound).

The preferred “compounds having 1 to 12 furanose or pyranose structures” are disclosed in, for example, Japanese Patent Application Laid Open Publication Nos. 562-42996 and H10-237084. Commercially available one is Monopet SB (Available from Dai-Ichi Kogyo Seiyaku Co., Ltd).

Preferably, the substrate (cellulose ester film) of the present invention contains 1 to 35 mass %, in particular 5 to 30 mass % compound having a furanose or pyranose structure.

<Other Plasticizer>

The substrate of the present invention may contain any other plasticizer required for achieving the advantageous effects of the present invention, in addition to the ester compound described above. The plasticizer is preferably selected from 1) polyvalent alcohol ester plasticizers, 2) polyvalent carboxylic acid ester plasticizers, 3) glycolate plasticizers, 4) phthalic or citric ester plasticizer, 5) fatty acid ester plasticizers, and 6) phosphate ester plasticizers. These plasticizers are preferably compounded in an amount in the range of 1 to 30 mass % to the cellulose ester.

### 1) Polyvalent Alcohol Ester Plasticizer

The polyvalent alcohol ester plasticizers are esters of polyvalent alcohols, represented by General Formula (3);

R₁—(OH)ₙ General Formula (3)

wherein R1 represents an organic group having a valency of n, and n represents an integer of 2 or more.

Examples of preferred polyvalent alcohol include ethylene glycol, propylene glycol, trimethylolpronane, and pentaerythritol.

Any known monocarboxylic acid can be used for preparation of polyvalent alcohol esters. Examples of such monocarboxylic acid include aliphatic, alicyclic, and aromatic monocarboxylic acids.

Preferred aliphatic monocarboxylic acids are linear or branched fatty acids having 1 to 32 carbon atoms, more preferably 1 to 20 carbon atoms, most preferably 1 to 10 carbon atoms.

Examples of preferred aliphatic monocarboxylic acid include cyclopentanecarboxylic acid, cyclohexanecarboxylic acid, cyclooctanecarboxylic acid, and derivatives thereof.

Examples of preferred aromatic monocarboxylic acid include benzoic acid; alkylated benzoic acids, such as toluic acid; aromatic monocarboxylic acids having two or more benzene rings, such as biphenylcarboxylic acid, naphthalenecarboxylic acid, tetralincarboxylic acid; and derivatives thereof. Particularly preferred is benzoic acid.

The polyvalent alcohol ester has a molecular weight in the range of preferably 300 to 1500, more preferably 350 to 750. One carboxylic acid or two or more carboxylic acids may be used for preparation of polyvalent alcohol esters. The OH groups in the polyvalent alcohol may be entirely or partially esterified.

Trimethylolpropane triacetate and pentaerythritol tetraacetate are also preferably used. In addition, the ester compound (A) represented by General Formula (I) disclosed in Japanese Patent Application Laid Open Publication No. 2008-88292 is preferably used.

2) Polyvalent Carboxylic Acid Ester Compound

The polyvalent carboxylic acid ester compound is composed of a polyvalent carboxylic acid having a valency of 2 or more, preferably in the range of 2 to 20 and an alcohol. The aliphatic polyvalent carboxylic acid preferably has a valency of 2 to 20, the aromatic and alicyclic polyvalent carboxylic acids each preferably have a valency in the range of 2 to 20.

The polyvalent carboxylic acid is represented by General Formula (4):

R₂(COOH)ₘ(OH)ₙ General Formula (4)

wherein R₂ represents an organic group having a valency of (m+n), m represents an integer of 2 or more, n represents an integer of 0 or more, the COOH group represents a carboxy group, and the OH group represents an alcoholic or phenolic hydroxy group.

Examples of the preferred polyvalent carboxylic acid include divalent or higher-valent aromatic carboxylic acids, such as phthalic acid, terephthalic acid, isophthalic acid, trimellitic acid, trimesic acid, and pyromellitic acid, and derivatives thereof; polyvalent aliphatic carboxylic acids, such as succinic acid, adipic acid, azelaic acid, sebacic acid, formic acid, fumaric acid, maleic acid, and tetrahydrophthalic acid; polyvalent oxycarboxylic acids, such as tartaric acid, tartronic acid, malic acid, and citric acid.

Known alcohols and phenols can be used for preparation of polyvalent carboxylic ester compounds in the present invention. Preferred are, for example, saturated linear or branched aliphatic alcohols having 1 to 32 carbon atoms.

The number of carbon atoms ranges from preferably 1 to 20, more preferably 1 to 10. Also preferred are alicyclic alcohols, such as cyclopentanol and cyclohexanol, and derivatives thereof; and aromatic alcohols, such as benzyl alcohol and cinnamyl alcohol, and derivatives thereof. Phenols, such as phenol, p-cresol, and dimethylphenol can be used alone or in combination.

In a preferred embodiment, the ester compound (B) represented by General Formula (II) disclosed in Japanese Patent Application Laid Open Publication No. 2008-88292 is used.

The polyvalent carboxylic acid ester compound preferably in the range of 300 to 1000, more preferably in the range of 350 to 750, although it may have any molecular weight.

One alcohol or two or more alcohols may be used for preparation of the polyvalent carboxylic acid ester.

The polyvalent carboxylic acid ester compound has an acid value of preferably 1 mg KOH/g or less, more preferably 0.2 mgKOH/g or less.

The acid value indicates milligrams of potassium hydroxide necessary for neutralization of acid contained 1 g of sample (carboxy group present in the sample). The acid value is determined in accordance with JIS K0070.

3) Glycolate Plasticizer

Preferred examples of the glycolate plasticizer include, but not limited to, alkyl phthalyl alkyl glycolates. Examples of the alkyl phthalyl alkyl glycolates include methyl phthalyl methyl glycolate, ethyl phthalyl ethyl glycolate, propyl phthalyl propyl glycolate, butyl phthalyl butyl glycolate, and octyl phthalyl octyl glycolate.

4) Phthalic or Citric Ester Plasticizer

Examples of the phthalic ester plasticizer include diethyl phthalate, dimethoxyethyl phthalate, dimethyl phthalate, dioctyl phthalate, dibutyl phthalate, di-2-ethylhexyl phthalate, dioctyl phthalate, dicyclohexyl phthalate, and dicyclohexyl terephthalate.

Examples of the citric ester plasticizer include acetyl trimethyl citrate, acetyl triethyl citrate, and acetyl tributyl citrate.

5) Fatty Acid Ester Plasticizer

Examples of the fatty acid ester plasticizer include butyl oleate, methyl acetyl ricinolate, and dibutyl sebacate.

6) Phosphate Ester Plasticizer

Examples of phosphate ester plasticizers include triphenyl phosphate, tricresyl phosphate, cresyl diphenyl phosphate, octyl diphenyl phosphate, diphenyl biphenyl phosphate, trioctyl phosphate, and tributyl phosphate.

<UV absorber>

The substrate of the present invention preferably contains an UV absorber. The UV absorber absorbs UV rays of 400 nm or shorter and improves the durability. In particular, the transmittance at a wavelength of 370 nm is preferably 30% or less, more preferably 20% or less, most preferably 10% or less.

Examples of the UV absorber usable in the present invention include, but not limited to, oxybenzophenone compounds, benzotriazole compounds, salicylic ester compounds, benzophenone compounds, cyanoacrylate compounds, triazine compounds, nickel complex compounds, and inorganic powder.

The amount of the UV absorber to be used depends on the type and the condition for the use of the UV absorber, and ranges from preferably 0.5 to 10 mass %, more preferably 0.6 to 4 mass % to the substrate having a dried thickness in the range of 5.0 to 25 μm.

<Microparticles>

The substrate of the present invention preferably contains microparticles in view of improved slippage and storage stability.

Examples of inorganic microparticles include silicone dioxide, titanium dioxide, aluminum oxide, zirconium oxide, calcium carbonate, talc, clay, calcined kaolin, calcined calcium silicate, hydrated calcium silicate, aluminum silicate, magnesium silicate, and calcium phosphate. Silicone-based microparticles, in particular silicon dioxide, are preferred due to low turbidity (low haze).

Silicon dioxide is preferably subjected to hydrophobic treatment in view of compatibility between slippage and haze. It is preferred that two or more, more preferably 3 or more silanol groups among four silanol groups be replaced with hydrophobic groups. A preferred hydrophobic substituent group is methyl group.

The silicone dioxide primary particles have a particle size of preferably 20 nm or less, more preferably 10 nm or less.

Microparticles of silicon dioxide are commercially available under trade names, for example, Aerosil R972, R972V, R974, R812, 200, 200V, 300, R202, OX50, and TT600 (Nippon Aerosil Co., Ltd.).

Microparticles of zirconium oxide are commercially available under trade names, for example, Aerosil R976 and R811 (Nippon Aerosil Co., Ltd.).

Examples of polymer microparticles include organic microparticles consisting of silicone resins, fluorinated resins, and acrylic resins. Among these polymers, silicone resins, in particular silicone resins having three-dimensional structures, are preferred, which are commercially available under trade name of Tospearl 103, 105, 108, 120, 145, 3120, and 240 (Toshiba Silicone).

Among these, particularly preferred are Aerosil 200V and R972V, which can reduce the friction coefficient while maintaining low haze of the substrate. Most preferred in the present invention is Aerosil R812 (primary particle size: about 7 nm, silicon dioxide nanoparticles surface-treated with trimethylsilyl groups). At least one side of the substrate of the present invention has a dynamic friction coefficient in the range of 0.2 to 1.0.

<Dye>

The substrate of the present invention may contain any dye to control the color. For example, a blue dye may be added to reduce the yellowish color of the substrate. Preferable dyes are anthraquinone dyes.

(Method for Manufacturing Substrate)

The method for manufacturing the substrate of the present invention will now be described.

The substrate of the present invention can be produced by a common solution casting or melt casting process. A method for making the substrate of the present invention by solution casting will now be described as an exemplary method.

The substrate of the present invention can be produced by the following solution casting processes involving a dope preparing step that dissolves the cellulose ester and additives described above in a solvent to prepare a dope; a casting step that casts the dope onto a metal endless support; a first drying step that dries the cast dope into a web; a detaching step that detaches the dried web from the metal support; a stretching step that stretches the web or keeps the width; a second drying step that further dries the web; and a winding step that winds up the finished film.

<Dope Preparing Step>

The dope preparing step will now be described. A higher cellulose ester concentration in the dope is preferred due to low drying step load after casting onto the metal support. An excessively high concentration leads to increased filtration load and reduced filtration precision. The concentration compatible with these factors ranges from preferably 10 to 35 mass %, more preferably 15 to 25 mass %.

Solvents used in preparation of the dope may be used alone or in combination. A mixture of a good solvent and a poor solvent for the cellulose ester is preferred in view of production efficiency. Examples of particularly preferred good solvent include methylene chloride and methyl acetate. Examples of the poor solvent include methanol, ethanol, butanol, cyclohexane, and cyclohexanone.

With the preferred ratio of the good solvent to the poor solvent, the good solvent typically is within the range of 70 to 98 mass %, whereas the poor solvent 2 to 30 mass %. In the present invention, the good solvent alone can dissolve the cellulose ester of the present invention, while the poor solvent alone can not dissolve or swell the cellulose ester. Thus, the boundary between the good solvent and the poor solvent shifts depending on the degree of acetyl substitution of the cellulose ester.

Preferably, the dope contains 0.01 to 2 mass % water. The solvent used in dissolution of the cellulose ester can be removed from the film during the film forming step (drying step) to be recycled.

The cellulose ester can be dissolved in a common manner during the preparation of the dope. A combination of heat and pressure enables the solvent to be heated to a temperature exceeding the boiling point at normal pressure. Such agitation dissolution at a temperature not causing boiling of the solvent under pressure can prevent formation of undissolved mass components called gel or lump.

This cellulose ester solution is filtered through any proper filter such as filter paper. A preferred filter has an absolute filtering accuracy of 0.008 mm or less, more preferably 0.001 to 0.008 mm, most preferably 0.003 to 0.006 mm.

Any type of commonly used filter can be used. Plastic filters made of polypropylene and Teflon (registered trade name) and metal filters made of stainless steel are preferred, which do not cause detachment of fiber.

The dope can be filtered by a common procedure. Hot filtration at a temperature above the boiling point of the solvent under normal pressure and below the boiling point of the solvent under pressurized conditions is preferred because the difference in pressure (differential pressure) across the filter is small. The filtration temperature ranges from preferably 45 to 120° C., more preferably 45 to 70° C., most preferably 45 to 55° C.

It is preferred that the filtration pressure be as much as small. The filtration pressure is preferably 1.6 MPa or less, more preferably 1.2 MPa or less, most preferably 1.0 MPa or less.

<Casting Step>

The casting step of the dope will now be described.

The surface of the metal support used during the casting step is preferably mirror-polished. Examples of the metal support include steel belts and cast metal drums that are finished by plating. The resulting cast has a width in the range of 1 to 4 m.

The surface temperature of the metal support during the casting step ranges preferably from −50° C. to less than the boiling point of the solvent, more preferably from 0 to 40° C., most preferably 5 to 30° C.

(Drying Step and Detaching Step)

To achieve high flatness of the substrate (cellulose ester film), the residual solvent content in the web detached from the metal support ranges preferably from 10 to 150 mass %, more preferably from 20 to 40 mass % or from 60 to 130 mass %, most preferably from 20 to 30 mass %, from 70 to 120 mass %.

The residual solvent content in the present invention is defined as follows:

Residual solvent content (mass %)={(M−N)/N}×100 wherein M represents the mass of the sample collected at any point during or after the production of the web or film, and N represents the mass after heating at 115° C. for 1 hr.

In the drying step of the substrate (cellulose ester film), it is preferred that the web be detached from the metal support and be further dried until the residual solvent content becomes 1 mass % or less, more preferably 0.1 mass % or less, most preferably in the range of 0 to 0.01 mass %.

The film drying step is carried out by a roller drying process in which the web travels through multiple upper and lower rollers alternately or a tenter process in which the web is transferred to be dried.

The web can be dried by any means. Examples of such means include hot wind, infrared rays, hot rollers, and microwave heating. Among them preferred is hot wind, which is easy-to use.

The drying temperature of the web in the drying step is within the range of 90 to 200° C., more preferably 110° C. to 190° C. It is preferred that the drying temperature be gradually raised.

The preferred drying time ranges from about 5 to 60 minutes, more preferably 10 to 30 minutes, although it depends on the drying temperature.

The substrate may be any thickness and preferably ranges from 5.0 to 25 μm to achieve the advantageous effects of the present invention.

The substrate (cellulose ester film) used in the present invention has a width of 1 to 4 m. The width preferably ranges from 1.6 to 4 m, more preferably 1.8 to 3.6 m in view of productivity. A width of 4 m or less ensures stable transfer.

<Stretching Step>

The substrate (cellulose ester film) of the present invention can be produced through stretching a web that is detached from the metal support and contains a relatively large amount of residual solvent in the machine direction (MD) and then stretching it in the transverse direction (TD) while both edges of the web is being gripped with clips in a tenter system.

It is preferred that the web be stretched successively or simultaneously in the machine direction (MD) and the transverse direction (TD) of the film. The final draw ratios in the two orthogonal directions preferably range from 1.0 to 2.0 in the MD and 1.07 to 2.0 in the TD, more preferably range from 1.0 to 1.5 in the MD and 1.07 to 2.0 in the TD.

Examples of the stretching step include stretching in the MD by a difference in circumferential velocity between two or more rollers, stretching in the MD by enlarging the distances between clips or pins used for fixation of the two edges of the web in the travelling direction of the web, stretching in the TD by enlarging the distances between the clips or pins in the transverse direction, and simultaneously stretching in the MD and TD.

In the film forming step, the fixation of the width or the stretching in the transverse direction is preferably carried out with a tenter, for example, a pin tenter or a clip tenter.

The tension for transfer the film in the film forming step in the tenter depends on the temperature and ranges preferably from 120 to 200 N/m, more preferably 140 to 200 N/m. A tension within the range of 140 to 160 N/m is most preferred.

The stretching temperature is within the range of typically (Tg−30) to (Tg+100)° C., preferably (Tg−20) to (Tg+80)° C., more preferably (Tg−5) to (Tg+20)° C., where Tg represents the glass transition temperature of the substrate of the present invention.

The Tg of the substrate can be adjusted by the materials to be compounded in the film and the proportion of these materials. In the application according to the present invention, the Tg of the dry film is preferably 110° C. or more, more preferably 120° C. or more.

The glass transition temperature therefore is preferably 190° C. or less more preferably 170° C. or less. The Tg of the film can be determined by a method in accordance with JIS K 7121.

It is preferred in the present invention that the stretching temperature be 150° C. or more and the draw ratio be 1.15 or more to make an adequately rough surface. The rough surface of the film is preferred since it improves slippage and surface processing characteristics, in particular, adhesiveness with a hard coat layer. The average surface roughness Ra ranges preferably 2.0 nm to 4.0 nm, more preferably 2.5 nm to 3.5 nm. During the stretching, the film preferably contains hydrophobilized silicon dioxide particles described above. R972V and R812 are particularly preferred for stabilization to haze.

The surface roughness Ra (nm) of the substrate and the polarity to the solvent of the substrate preferably have the following relation:

Ra≦3.5×log P−25.4

### <Heat Fixation>

The cellulose ester film of the substrate of the present invention is preferably thermally fixed after the stretching step. The heat fixation is carried out within the range from above the stretching temperature at the final TD to Tg−20° C. or less for a time between 0.5 and 300 sec. The film is preferably thermally fixed while being gradually heated in at least two separate regions having a difference in temperature of 1 to 100° C.

The thermally-fixed film is generally cooled to a glass transition temperature Tg or less, and is cut at the opposite portions held by the clips to be rolled up. During the cooling from the final temperature of the thermal fixation or less to Tg or more, the film is preferably relaxed in 0.1 to 10% in the TD or MD.

The cooling from the last temperature of the thermal fixation to Tg is preferably carried out at 100° C./sec or less. Any known scheme can be used for the cooling and relaxation processes, and particularly preferred is gradual cooling in multiple temperature regions for improved dimensional stability of the film.

The cooling rate is determined by (T1−Tg)/t, wherein T1 represents the final temperature of the thermal fixation, t represents the time to cool the film from the final temperature of the thermal fixation to Tg.

Optimal conditions for the thermal fixation, cooling, and relaxation, which depend on the types of additives, such as cellulose ester and plasticizer, contained in the substrate, may be appropriately controlled on the basis of the measured properties of the biaxially stretched film to achieve preferred characteristics.

It is preferred that the substrate according to the present invention have a slow axis or fast axis in the film plane and the angle θ1 defined by the axis and the travelling direction of the film range preferably from −1° to +1°, more preferably −0.5° to +0.5°.

The angle θ1 can be defined as an orientation angle that can be determined with an automatic birefringent meter KOBRA-21ADH (Oji Scientific Instruments). An angle θ1 within the range contributes to high luminance in displayed images, a prevention or reduction in light leakage, and accurate color production in color liquid crystal display devices.

(Physical and Optical Properties)

The moisture permeability of the substrate according to the present invention is preferably in the range of 10 to 1200 g/m²·24 h at 40° C., 90% RH, more preferably 20 to 1000 g/m²·24 h, and most preferably 20 to 850 g/m²0.24 h. The moisture permeability can be determined by a method in accordance with JIS Z 0208.

The storage elastic modulus at 30° C. of the substrate according to the present invention is preferably in the range of 3.2 to 4.7 GPa in the MD, and in the range of 4.7 to 7.0 GPa in the TD for preventing a longitudinal kink. The storage elastic modulus can be determined with a dynamic viscoelastometer (“ARES” available from Rheometric Co.) in a heating mode (the heating rate: 5° C./min, frequency: 10 Hz) at 30° C.

The visible light transmittance of the substrate according to the present invention is preferably 90% or more, more preferably 93% or more. The visible light transmittance can be determined by measuring a spectral transmission in the visible light range every 10 nm wavelength and calculating the average value of the spectral transmission with a spectrophotometer (for example, U3400 from Hitachi, Ltd.).

The haze of the substrate according to the present invention is preferably less than 1%, and particularly preferably in the range of 0 to 0.4%. The haze can be determined with a hazemeter NDH2000 available from Nippon Denshoku Industries Co., Ltd., at 23° C. and 55% RH, in accordance with JIS K7136.

The substrate of the present invention has an in-plane retardation Ro and thickness retardation Rt that are represented by the respective formulae shown below. In a preferred embodiment, the in-plane retardation Ro is in the range of 0 to 150 nm, and the thickness retardation Rt is in the range of −100 to 300 nm. In a particularly preferred embodiment, Ro is in the range of 0 to 10 nm, and Rt is in the range of 0 to 100 nm.

Ro=(nx−ny)×d Formula (i)

Rt=((nx+ny)/2−nz)×d Formula (ii)

wherein Ro represents an in-plane retardation of a film, Rt represents a thickness retardation of a film, nx represents a refractive index in the slow-axis direction in the plane of a film, ny represents a refractive index in the fast-axis direction in the plane of a film, nz represents a refractive index in the thickness direction of a film, and d represents the thickness (nm) of a film.

These retardations can be determined with, for example, KOBRA-21ADH (from Oji Scientific Instruments), under the conditions of 23° C., 55% RH, 590 nm wavelength.

In the present invention, the preferred Rt for film thickness of 1 μm is 0.85 nm or more. A thin film having Rt of a predetermined value or more is preferred to ensure a desirable contrast and view angle. For example, if the film has a thickness in the range of 30 to 50 μm, the preferred Rt is in the range of 26 to 200 nm, or if the film has a thickness in the range of 50 to 70 μm, the preferred Rt is in the range of 43 to 200 nm. The Rt for film thickness of 1 μm ranges more preferably from 0.9 to 5.0 nm, further preferably from 1 μm is 1.0 to 5.0 nm.

(Hard Coat Layer)

One of the features of the substrate according to the present invention is a hard coat layer that has a thickness in the range of 1.0 to 5.0 μm and that is disposed on at least one surface of the substrate.

The thin substrate provided with a hard coat layer having a high surface hardness thereon according to the present invention can be highly resistant to external pressure.

A preferred hard coat layer applicable to the present invention is composed of active-ray-curing resin. In specific, the hard coat layer according to the present invention is preferably composed primarily of active-ray-curing resin to be cured through a cross-linking reaction caused by active rays (also called active energy rays) such as ultraviolet rays or electron rays.

The hard coat layer can be preferably composed of any active-ray-curing resin, which is a component including a monomer having an ethylenically unsaturated double bond and is cured by active rays such as ultraviolet rays and electron rays to form the active-ray-curing resin layer. Examples of the active-ray-curing resin include ultraviolet curable resins and electron beam curable resins, and preferred is UV-curable resins for a high mechanical strength (abrasion-resistance and pencil hardness) in a film. Preferred examples of the UV-curable resin include radical polymerization resins, such as an UV-curable acrylate resins, UV-curable urethane acrylate resins, UV-curable polyester acrylate resins, UV-curable epoxy acrylate resins, and UV-curable polyol acrylate resins, and cation polymerization resins, such as UV-curable epoxy resins. Particularly preferred is UV-curable acrylate resins, which are radical polymerization resins.

Preferred UV-curable acrylate resins are polyfunctional acrylate compounds. The polyfunctional acrylate compounds are preferably selected from the group consisting of pentaerythritol polyfunctional acrylates, dipentaerythritol polyfunctional acrylates, pentaerythritol polyfunctional methacrylates, and dipentaerythritol polyfunctional methacrylates. The term polyfunctional acrylate refers to a compound having two or more acryloyloxy groups or methacryloxy groups in a molecule. Examples of the preferred polyfunctional acrylate monomer include ethylene glycol diacrylate, diethylene glycol diacrylate, 1,6-hexanediol diacrylate, neopentyl glycol diacrylate, trimethylolpropane triacrylate, trimethylolethane triacrylate, tetramethylolmethane triacrylate, tetramethylolmethane tetraacrylate, pentaglycerol triacrylate, pentaerythritol diacrylate, pentaerythritol triacrylate, pentaerythritol tri/tetraacrylate, ditrimethylolpropane tetraacrylate, ethoxylated pentaerythritol tetraacrylate, pentaerythritol tetraacrylate, glycerin triacrylate, dipentaerythritol triacrylate, dipentaerythritol tetraacrylate, dipentaerythritol pentaacrylate, dipentaerythritol hexaacrylate, tris(acryloyloxyethyl) isocyanumate, ethylene glycol dimethacrylate, diethylene glycol dimethacrylate, 1,6-hexanediol dimethacrylate, neopentyl glycol dimethacrylate, trimethylolpropane trimethacrylate, trimethylolethane trimethacrylate, tetramethylolmethane trimethacrylate, tetramethylolmethane tetramethacrylate, pentaglycerol trimethacrylate, pentaerythritol dimethacrylate, pentaerythritol trimethacrylate, pentaerythritol tetramethacrylate, glycerin trimethacrylate, dipentaerythritol trimethacrylate, dipentaerythritol tetramethacrylate, dipentaerythritol pentamethacrylate, dipentaerythritol hexamethacrylate, and isocyanurate derivatives curable by active rays.

Any active-ray-curable isocyanurate derivative may be used which has an isocyanuric acid skelton structure to which at least one ethylenically unsaturated group is bonded. Preferred is a compound having at least three ethylenically unsaturated groups and at least one isocyanurate ring in a molecule.

Examples of the active-ray-curable isocyanurate derivative that are commercially available include Adekaoptomer, N-series (available from ADEKA Corporation), SANRAD H-601, RC-750, RC-700, RC-600, RC-500, RC-611, and RC-612 (available from Sanyo Chemical Industries), SP-1509, SP-1507, ARONIX M-6100, M-8030, M-8060, ARONIX M-215, ARONIX M-315, ARONIX M-313, and ARONIX M-327 (available from Toagosei, Ltd), NK-ester A-TMM-3L, NK-ester AD-TMP, NK-ester ATM-35E, NK-ester ATM-4E, NK-ester A-DOG, NK ester A-IBD-2E, A-9300, and A-9300-1CL (available from Shin-Nakamura Chemical Co., Ltd), Light Acrylate TMP-A and PE-3A (available from Kyoeisha Chemical Co., Ltd).

Monofunctional acrylates may also be used. Examples of the monofunctional acrylate include isobornyl acrylate, 2-hydroxy-3-phenoxypropyl acrylate, isosteraryl acrylate, benzyl acrylate, ethylcarbitol acrylate, phenoxyethyl acrylate, lauryl acrylate, isooctyl acrylate, tetrahydrofurfuryl acrylate, behenyl acrylate, 4-hydroxybutyal acrylate, 2-hydroxyethyl acrylate, 2-hydroxypropylacrylate, and cyclohexyl acrylate. These monofunctional acrylate are available from Nihon Kasei Kogyo Co., Ltd., Shin-Nakamura Chemical Co., Ltd., and Osaka Organic Chemical Industry Ltd.

When the monofunctional acrylate is used, the mass ratio of the polyfunctional acrylate to the monofunctional acrylate is preferably in the range of 70:30 to 98:2.

The hard coat layer preferably contains photopolymerization initiator to accelerate curing of the active-ray-curable resin. The mass ratio of the photopolymerization initiator to the active-ray-curable resin is preferably in the range of 20:100 to 0.01:100. Specific examples of the photopolymerization initiator includes, but are not limited thereto, alkylphenones, acetopnenone, benzophenene, hydroxybenzophenene, Michler's ketone, α-amyloxime esters, thioxanthone, and derivatives thereof.

Any commercially-available photopolymerization initiator can be used, and preferred examples thereof include Irgacures 184, 907, and 651 available from BASF Japan Ltd.

The hard coat layer according to the present invention may contain a conductive agent to prevent electrification. Preferred examples of the conductive agent include n-electron conjugated conductive polymers. Ionic liquids are also preferred as conductive compounds.

The hard coat layer according to the present invention may contain a compound having a HLB value in the range of 3 to 18. The term HLB stands for hydrophile-lipophile-balance, which represents hydrophilicity or lipophilicity. A compound representing a smaller HLB value has higher lipophilicity, whereas a compound representing a higher HLB value has higher hydrophilicity.

The hard coat layer according to the present invention may include an acrylic copolymer, a silicone-based surfactant, a fluorinated surfactant, an anionic surfactant, or a fluorine-siloxane graft compound for enhanced coating properties.

The fluorine-siloxane graft compound is copolymer of at least a fluorine-based resin to which a polysiloxane or organo-polysiloxane copolymer composed of a siloxane or organosiloxane monomer unit is grafted.

The hard coat layer is formed by coating a substrate with a composition for the hard coat layer diluted in a solvent, drying the coated substrate, and irradiating the coated substrate with active rays to cure the coated substrate.

Preferred examples of the solvent includes ketones (e.g., methyl ethyl ketone, acetone, cyclohexanone, and methyl isobutyl ketone), esters (e.g., methyl acetate, ethyl acetate, butyl acetate, propyl acetate, and propylene glycol monomethyl ether acetate), alcohols (e.g., ethanol, methanol, butanol, n-propyl alcohol, isopropyl alcohol, and diacetone alcohol), hydrocarbons (e.g., toluene, xylene, benzene, and cyclohexane), and glycol ethers (e.g., propylene glycol monomethyl ether, propylene glycol monopropyl ether, and ethylene glycol monopropyl ether). Among these solvents particularly preferred are ketones, esters, glycol ethers, and alcohols, more preferred are glycol ethers and alcohols.

The composition for the hard coat layer in such a solvent, which is in the range of 20 to 200 parts by mass to the active-ray-curing resin of 100 parts by mass, is applied onto a substrate film, and the solvent of the composition for the hard coat layer is vaporized to form the hard coat layer.

The dry thickness (average thickness) of the hard coat layer is in the range of 1.0 to 5.0 μm. The wet thickness of the hard coat layer is substantially in the range of 5.0 to 50 μm, and preferably in the range of 5.0 to 30 μm, to achieve the dry thickness.

The hard coat layer may be formed by any known wet coater, such as a gravure coater, dip coater, reverse coater, wire bar coater, die coater, or ink-jet coater. Formation of the hard coat layer by these wet coaters involves coating a substrate with the composition for the hard coat layer, drying the coated substrate, irradiating the coated substrate with active rays (also referred to as UV curing process), and optionally heating the coated substrate after the UV curing process. The heating process after the UV curing process is preferably carried out at 80° C. or higher, more preferably at 100° C. or higher, and most preferably at 120° C. or higher. Such a high-temperature heating process after the UV curing process can provide a hard coat layer having excellent film strength.

The drying process in a falling rate drying section is preferably carried out at a high temperature of 90° C. or higher, and more preferably, in the range of 90 to 160° C.

Any light sources emitting ultraviolet rays may be used in the UV curing process. Examples of the light source include low-pressure mercury lamps, medium-pressure mercury lamps, high-pressure mercury lamps, ultra-high pressure mercury lamps, carbon-arc lamps, metal halide lamps, and xenon lamps.

The active-ray radiation is generally in the range of 50 to 1000 mJ/cm², and preferably 50 to 500 mJ/cm², although radiation conditions depend on the lamps to be used.

The hard coat layer according to the present invention may contain an ultraviolet absorber. The ultraviolet absorber, which absorbs ultraviolet rays of 400 nm or less, is used to enhance durability of the hard coat layer.

The ultraviolet absorber applicable to the present invention may be, but is not limited thereto, the same absorber as that for the substrate.

The transmission of the laminate of the substrate and the hard coat layer at a wavelength of 370 nm is preferably 30% or less, more preferably 20% or less, and particularly preferably 10% or less.

<Antiglare Treatment of Hard Coat Layer>

The hard coat layer of the present invention may be treated to have antiglare characteristics in accordance with the following procedure.

(1) Embossing with a roller or matrix having a negative embossing pattern.

(2) Filling a negative embossing pattern formed on a roller or matrix with a thermosetting resin, curing the resin, and then stripping the cured resin from the negative pattern.

(3) Applying an UV- or electron beam-curable resin solution onto a negative embossing pattern formed on a roller or matrix, disposing a transparent film substrate thereon, irradiating the resin solution through the substrate with UV rays or electron beams, and then stripping the cured resin bonded to the transparent film substrate from the genitive pattern.

(4) Casting a solution onto a casting belt having a negative embossing pattern to form a film having an intended pattern (solvent casting).

(5) Relief printing on a transparent substrate with photo- or heat-curable resin, and then curing the resin by light or heat to form unevenness.

(6) Ejecting droplets of photo- or heat-curable resin onto a surface of a hard coat layer by an ink-jet process, curing the resin with light or heat to form protrusions on the surface of the transparent film substrate.

(7) Ejecting droplets of photo- or heat-curable resin onto a surface of a hard coat layer by an ink-jet process, curing the resin with light or heat to form protrusions, and then covering the protrusions with a transparent resin layer.

(8) Milling the surface of a hard coat layer with a machine tool.

(9) Plunging spherical or polyhedron particles into the surface of the hard coat layer such that the particles are semi-embedded and integrated with the layer to form protrusions on the surface of the hard coat layer.

(10) Applying a dispersion of spherical or polyhedron particles in a small volume of binder onto the surface of the hard coat layer to form irregularity on the surface of the hard coat layer.

(11) Applying a binder onto the surface of the hard coat layer and spraying spherical or polyhedron particles thereon to form protrusions on the surface of the hard coat layer.

(12) Pressing the surface of the hard coat layer with a mold to form irregularity. Refer to Japanese Patent Application Laid Open Publication No. 2005-156615 for details.

Among these methods for forming irregularity onto the surface of the hard coat layer, a combination of formation of a negative pattern and an inkjet process is effective.

The term “antiglare characteristics” in the present invention refer to gradating the contour of an image reflected by the surface of the hard coat layer to decrease visibility of the reflected image such that the reflected image from the back face does not bother the viewer so much during use of an image display, such as a liquid crystal display, an organic EL display or a plasma display.

<Transparent Microparticle>

Transparent microparticles are preferably compounded in the formation of the hard coat layer to impart antiglare characteristics to the hard coat layer.

Transparent microparticles are preferably composed of two or more different types of particles to achieve internal and surface haze. A preferred combination of different types of particles is composed of a first transparent microparticle (also referred to as Transparent microparticle 1) having an average particle size of 0.01 to 1 μm and a second transparent microparticle (also referred to as Transparent microparticle 2) having an average particle size of 2 to 6 μm.

The average particle diameter of Transparent microparticle 1 ranges preferably from 0.01 to 1 μm, more preferably 0.05 μm to 1 μm. The average particle diameter of Transparent microparticle 2 ranges preferably from 2 to 6 μm, more preferably 3 to 6 μm.

An average particle size of Transparent microparticle 1 within the range of 0.01 to 1 μm can readily control the internal haze, and can more effectively prevent the decrease in the strength of the film after ozone exposure. An average particle size of Transparent microparticle 2 within the range of 2 to 6 μm provides a proper distribution of light scattering angle not causing unclear characters on the display. This size can prevent thickening of the antiglare hard coat layer and thus can reduce curling and material costs. The average particle size of the transparent microparticles can be determined, for example, with a laser diffraction particle size distribution sensor “HELOS & RODOS” made by SYMPATEC.

Examples of the second transparent microparticles having an average diameter in the range of 2 to 6 μm include acrylic particles, styrene particles, acryl-styrene particles, melamine particles, benzoguanamine particles, and inorganic particles primarily composed of silica. Preferred are, for example, fluorine-containing acrylic resin particles, poly(meth)acrylate particles, crosslinked poly(meth)acrylate particles, polystyrene particles, crosslinked polystyrene particles, and crosslinked poly(acrylic-styrene) particles. Among them, particularly preferred are fluorine-containing acrylic resins.

Examples of fluorine-containing acrylic resin particles include particles of monomers and polymers of fluorine-containing acrylic or methacrylic esters. Examples of the fluorine-containing acrylic or methacrylic ester include 1H,1H,3H-tetrafluoropropyl(meth)acrylate, 1H,1H,5H-octafluoropentyl(meth)acrylate, 1H,1H,7H-dodecafluoroheptyl(meth)acrylate, 1H,1H,9H-hexadecafluorononyl(meth)acrylate, 2,2,2-trifluoroethyl(meth)acrylate, 2,2,3,3,3-pentafluoropropyl(meth)acrylate, 2-(perfluorobutyl)eghyl(meth)acrylate, 2-(perfluorohexyl)ethyl(meth)acrylate, 2-(perfluorooctyl)ethyl)(meth)acrylate, 2-perfluorodecylethyl(meth)acrylate, 3-perfluorobutyl-2-hydroxypropyl(meth)acrylate, 3-perfluorohexyl-2-hydroxypropyl(meth)acrylate, 3-perfluorooctyl-2-hydroxypropyl(meth)acrylate, 2-(perfluoro-3-methylbutyl)ethyl(meth)acrylate, 2-(perfluoro-5-methylhexyl)ethyl(meth)acrylate, 2-(perfluoro-7-methyloctyl)ethyl(meth)acrylate, 3-(perfluoro-3-methylbutyl-2-hydroxypropyl(meth)acrylate, 3-(perfluoro-5-methylhexyl)-2-hydroxypropyl(meth)acrylate, 3-(perfluoro-7-methyloctyl)-2-hydroxypropyl(meth)acrylate, 1H-1-(trifluoromethyl)trifluoroethyl(meth)acrylate, 1H,1H,3H-hexafluorobutyl(meth)acrylate, trifluoroethyl metacrylate, tetrafluoropropyl methacrylate, perfluorooctylethyl acrylate, and 2-(perfluorobutyl)ethyl α-fluoroacrylate.

Among the fluorine-containing acrylic resin microparticles, preferred are 2-(perfluorobutyl)ethyl α-fluoroacrylate microparticles, fluorine-containing poly(methyl methacrylate) microparticles, and microparticles of copolymers of fluorine-containing methacrylic acid with vinyl monomers in the presence of cross-linking agents. More preferred are fluorine-containing poly(methyl methacrylate) microparticles.

Examples of vinyl monomers copolymerizable with fluorine-containing (meth)acrylic acids include alkyl methacrylate esters, such as methyl methacrylate, butyl methacrylate; alkyl acrylate esters, such as methyl acrylate and ethyl acrylate; and styrene and its derivatives, such as α-methyl styrene. These monomers may be used alone or combination. Any cross-linking agent may be used for polymerization reaction. Preferably cross-linking agents have two or more unsaturated groups. Examples of such cross-linking agent include difunctional dimethacrylates, such as ethylene glycol dimethacrylate and polyethylene glycol dimethacrylate; trimethylolpropane trimethacrylate; and divninylbenzene.

The polymer for preparation of the fluorine-containing polymethyl methacrylate particles may be a random copolymer or block copolymer. The method of these copolymers is disclosed in, for example, Japanese Patent Application Laid Open Publication No. 2000-169658.

Examples of commercially available polymers include MF-0043 made by Negami Chemical Industrial Co., Ltd. The fluorine-containing acrylic resin microparticles may be used alone or in combination. The fluorine-containing acrylic resin microparticles may be added in any form, for example, powder or emulsion.

The fluorine-containing cross-linked microparticles disclosed on paragraphs (0028) to (0055) in Japanese Patent Application Laid Open Publication No. 2004-83707 may be used.

Examples of commercially available polystyrene particles include SX series (e.g., SX-130H, SX-200H, and SX-350H) made by Soken Chemical & Engineering Co., Ltd. and SBX series (e.g., SBX-6 and SBX-8) made by SEKISUI PLASTICS CO., Ltd.

Examples of commercially available melamine particles include the condensation products of benzoguanamine-melamine-formaldehyde (commercial name: Epostar Grade M30, Epostar GP Grades H40 to H110) and condensation products of melamine-formaldehyde (commercial name: Epostar Grades S12, S6, S, and SC4) made by Nippon Shokubai Co., Ltd. Core-shell type spherical composite cured melamine resin particles composed of melamine resin cores and silica shells can also be used. Such particles can be prepared by a method disclosed in Japanese Patent Application Laid Open Publication No. 2006-171033 and an example is composite particles of melamine resin and silica, commercially available from Nissan Chemical Industries, Ltd. under the trade name Optobeads.

Examples of commercially available poly(meth)acrylate particles and crosslinked poly(meth)acrylate particles include MX series (e.g., MX150 and MX300) made by Soken Chemical & Engineering Co., Ltd., Epostar MA, Grades MA1002, MA1004, MA1006, and MA1010, and Epostar MX (emulsion), Grades MX020W, MX030W, MX050W, and MX100W made by Nippon Shokubai Co., Ltd., and MBX series (e.g., MBX-8 and MBX12) made by SEKISUI PLASTICS CO., Ltd.

Examples of commercially available cross-linked poly (acrylic-styrene) particles include FS-201 and MG-351 made by NIPPON PAINT Co., Ltd. Examples of commercially available benzoguanamine particles include condensation products of benzoguanamine and formaldehyde (commercial name: Epostar, Grades L15, M05, MS, and SC25) made by Nippon Shokubai Co., Ltd.

The content of the second transparent microparticles having an average diameter in the range of 2 to 6 μm ranges preferably from 0.01 to 500 parts by mass, more preferably from 0.1 to 100 parts by mass, most preferably from 1 to 60 parts by mass relative to 100 parts by mass of active ray curable resins in view of stability of the hard coat layer coating solution providing antiglare characteristics and dispersibility of the dispersion.

Examples of the first transparent microparticles having an average diameter of 0.01 to 1 μm include acrylic particles and inorganic particles primarily composed of silica. Examples of silica particles include commercially available products, such as Aerosil 200, 200V, and 300 made by Nippon Aerosil Co., Ltd., Aerosil OX50 and TT600 made by Degussa, and KEP-10, KEP-50, and KEP-100 made by Nippon Shokubai Co., Ltd. Colloidal silica may also be used. Colloidal silica is colloidal dispersion of silicon dioxide in water or organic solvent and typically present in the form of spheres, needles, or beads on a string. Examples of colloidal silica include commercial products, such as SNOWTEX series made by Nissan Chemical Industries, Ltd., CATALOID-S series made by Nippon Shokubai Co., Ltd., and LEVASIL series made by Bayer. Beaded colloidal silica is also preferred that is composed of primary particles of silica or colloidal silica cationized with alumina sol or aluminum hydroxide and the primary particles are bonded in series with di- or higher-valent metallic ions. Examples of beaded colloidal silica include SNOWTEX-AK series, SNOWTEX-PS series, and SNOWTEX-UP series made by Nissan Chemical Industries, Ltd. Specific Examples include IPS-ST-L (isopropyl alcohol silica sol, particle size: 40 to 50 nm, the silica content: 30%), MEK-ST-MS (methyl ethyl ketone silica sol, particle size: 17 to 23 nm, silica content: 35%), MEK-ST (methyl ethyl ketone silica sol, particle size: 10 to 15 nm, silica content: 30%), MEK-ST-L (methyl ethyl ketone silica sol, particle size: 40 to 50 nm, silica content: 30%), and MEK-ST-UP (methyl ethyl ketone silica sol, particle size: 9 to 15 nm (chain structure), silica content: 20%).

Examples of acrylic-based particles include fluorine-containing acrylic resin particles, such as FS-701 made by NIPPON PAINT Co., Ltd. Examples of acrylic particles include S-4000 made by NIPPON PAINT Co., Ltd, and examples of acryl-styrene particles include S-1200 and MG-251 made by NIPPON PAINT Co., Ltd.

Among these first transparent microparticles having an average particle size of 0.01 to 1 μm preferred are fluorine-containing acrylic resin microparticles.

The content of the first transparent microparticles having an average diameter of 0.01 to 1 μm ranges preferably from 0.01 to 500 parts by mass, more preferably from 0.1 to 100 parts by mass relative to 100 parts by mass of resin for forming a hard coat layer in view of stability of the coating solution for a hard coat layer providing antiglare characteristics and stability of the dispersion.

The ratio of the first transparent microparticles (Transparent microparticle 1) having an average diameter of 0.01 to 1 μm to the second transparent microparticles (Transparent microparticle 2) having an average diameter of 2 to 6 μm is preferably in the range of 1.0:1.0 to 3.0:1.0. A combination of two different types of microparticles having different diameters in a specific ratio provides a strong film resistant to endurance tests, such as ozone exposure.

The transparent microparticles can be added in any form, for example, powder or emulsion. The microparticles have a density in the range of preferably 10 to 1000 mg/m², more preferably 100 to 700 mg/m².

To achieve antiglare characteristics, UV-curable resin compositions may be added, such as silicone resin powder, polystyrene resin powder, polycarbonate resin powder, polyolefin resin powder, polyester resin powder, polyamide resin powder, polyimide resin powder, and polyfluoroethylene resin powder. Microparticles disclosed in Japanese Patent Application Laid Open Publication No. 2000-241807 may also be added, if necessary.

The refractive index of the transparent microparticles ranges preferably from 1.45 to 1.70, more preferably 1.45 to 1.65. The refractive index of the transparent microparticles can be determined with an Abbe refractometer in which an identical amount of transparent microparticles are dispersed in mixed solvents composed of two solvents having different refractive index in different ratios, the turbidity of each solution is measured, and the refractive index of the solvent mixture giving a minimum turbidity is defined as that of the transparent microparticles.

An absolute difference in refractive index between transparent microparticles and a transparent resin described later (refractive index of transparent microparticles−refractive index of transparent resin) is in the range of typically 0.001 to 0.100, preferably 0.001 to 0.050, more preferably 0.001 to 0.040, more preferably 0.001 to 0.030, more preferably 0.001 to 0.020, most preferably 0.001 to 0.015. The refractive index can be adjusted to such a range through selection of the type of the transparent resin and the transparent microparticles and the proportion therebetween. It is preferred that the selection be experimentally determined. The range defined above does not cause unclear characters on the film, a decrease in contrast in a dark chamber, or surface turbidity.

A combination of a curable acrylate hard coat forming resin having a refractive index after curing of 1.50 to 1.53 and an acrylic transparent microparticles is preferred. In particular, a combination of a curable acrylate resin having a refractive index after curing of 1.50 to 1.53 and acrylic transparent microparticles (refractive index of 1.48 to 1.54) composed of a crosslinked styrene-acryl copolymer and a combination of a curable acrylate resin having a refractive index after curing of 1.50 to 1.53, acrylic transparent microparticles, and fluorine-containing acrylic resin microparticles (refractive index of 1.45 to 1.47) are preferred.

[Polarizer]

As described above, the polarizer of the present invention is formed by laminating the hydrophilic polymer layer onto the thermoplastic resin layer by a coating process and the hydrophilic polymer layer has a thickness after stretching in the range of 0.5 to 10 μm.

[Thermoplastic Resin Layer]

In the present invention, a hydrophilic polymer layer is laminated onto the thermoplastic resin layer, and the laminate is stretched to form a stretched laminate.

The thermoplastic resin layer functions as a substrate onto which a hydrophilic polymer layer is to be formed. The thermoplastic resin layer of the present invention may be the same film for the substrate (protective film) for the polarizing plate described above, where the thickness of the thermoplastic resin layer is preferably within the range of 5 to 60 μm.

The thermoplastic resin used for forming the thermoplastic resin layer of the present invention may be the same material for the substrate. Examples of such material include, but not limited to, cellulose resins, such as triacetyl cellulose, polyester resins, such as polyethylene terephthalate and polyethylene naphthalate, polyether sulfone resins, polysulfone resins, polycarbonate resins, polyamide resins, such as nylon and aromatic polyamides, polyimide resins, polyolefin resins, such as polyethylene, polypropylene, and ethylene-propylene copolymers, cyclic polyolefin resins having cyclic or norbornene structures (norbornene resins), (meth)acrylic resin, polyarylate resins, polystyrene resins, poly(vinyl alcohol) resins, and mixtures thereof. Among them, films of cellulose ester resins and polyethylene terephthalate are preferred. More preferred are films of cellulose esters made by melt casting.

[Hydrophilic Polymer Layer]

The stretched laminate of the present invention has a hydrophilic polymer layer. The hydrophilic polymer layer contains a hydrophilic polymer as a primary component. The hydrophilic polymer layer of the polarizing plate of the present invention contains an adsorbed dichroic substance. The hydrophilic polymer layer functions as a polarizer in the polarizing plate of the present invention.

The hydrophilic polymer layer may be composed of any hydrophilic polymer, preferably composed of a poly(vinyl alcohol) material. Examples of the poly(vinyl alcohol) material include poly(vinyl alcohol) and derivatives thereof. Examples of the poly(vinyl alcohol) derivatives include poly(vinyl formal) and poly(vinyl acetal), which may be modified with olefins, such as, ethylene and propylene, unsaturated carboxylic acids, such as acrylic acid, methacrylic acid, and crotonic acid, and alkyl esters thereof, and acryl amide. The degree of polymerization of poly(vinyl alcohol) ranges preferably from about 100 to about 10000, more preferably from about 1000 to about 10000. The degree of saponification typically ranges from 80 to 100 mol %. Other examples of the hydrophilic polymer include partially saponified ethylene-vinyl acetate copolymers, dehydrated poly(vinyl alcohol), and dehydrochlorinated poly(hydrogen chloride). With the hydrophilic polymer described above, poly(vinyl alcohol) is preferred among the poly(vinyl alcohol) materials.

The hydrophilic polymer layer may further contain additives, such as plasticizer and surfactant, in addition to the hydrophilic polymer described above. Examples of the plasticizer include polyols and condensation products thereof, such as glycerin, diglycerin, trigrycerin, ethylene glycol, propylene glycol, and polyethylene glycol). The additives may be compounded in any amount, preferably 20 mass % or less to the total mass of the hydrophilic polymer layer.

The hydrophilic polymer layer is then dyed.

The dyeing process in the present invention is carried out by adsorbing a dichroic substance onto the hydrophilic polymer layer of the laminate including the thermoplastic resin layer. The dyeing treatment is carried out by immersing the laminate in a dichroic substance containing solution (dyeing solution), which will be described below in detail. The dyeing solution consists of a dichroic substance and a solvent. Typical solvent is water, and any organic solvent miscible with water may be further added.

Examples of dichroic substance to be adsorbed on the hydrophilic polymer layer include, but not limited to, iodine and organic dyes. Examples of the organic dye include Red BR, Red LR, Red R, Pink LB, Rubin BL, Bordeaux GS, Sky Bule LG, Lemonyellow, Blue BR, Blue 2R, Navy RY, Green LG, Violet LB, Violet B, Black H, Black B, Black GSP, Yellow 3G, Yellow R, Orange LR, Orange 3R, Scarlet GL, Scarlet KGL, Congo Red, Brilliant Violet BK, Supra Blue G, Supra Blue GL, Supra Orange GL, Direct Sky Blue, Direct Fast Orange S, and Fast Black. Use of water soluble iodine as a dichroic substance is preferred in view of high dyeing efficiency in any step. More preferred is an iodide. Examples of the iodide include potassium iodide, lithium iodide, sodium iodide, zinc iodide, aluminum iodide, lead iodide, copper iodide, barium iodide, calcium iodide, tin iodide, and titanium iodide. These iodides are added in an amount in the range of preferably 0.01 to 10 mass %, more preferably 0.1 to 5 mass % in the dyeing solution. Among them, potassium iodide is preferred. The mass ratio of iodine: potassium iodide is within the range of preferably 1:5 to 1:100, more preferably 1:6 to 1:80, most preferably 1:7 to 1:70.

The laminate may be immersed in a dyeing solution for any time period, preferably 15 seconds to 5 minutes, more preferably 1 to 3 minutes. The temperature of the dyeing solution ranges from preferably 10 to 60° C., more preferably 20 to 40° C. The dyeing treatment involves adsorption of a dichroic substance on the hydrophilic polymer layer of the laminate and alignment of the dichroic substance. The dyeing treatment may be performed before, during, or after the stretching treatment of the laminate. Dyeing treatment after the stretching treatment is preferred because the absorbed dichroic substance can be satisfactorily aligned on the hydrophilic polymer layer.

[Method for Manufacturing Polarizer]

The polarizer of the present invention is produced in the form of a stretched laminate having a polarizer through lamination of a hydrophilic polymer layer on a thermoplastic resin layer by a coating process and stretching of the laminate in the TD or MD. The method for making the polarizer of the present invention will now be described.

The stretched laminate of the present invention can be appropriately produced with reference to any known process and the description in Examples described below, without any limitation.

An exemplary method of making the stretched laminate of the present invention involves applying an aqueous hydrophilic polymer solution onto a thermoplastic resin layer by a wet process, drying the product, and stretching the laminate. In the method of making the stretched laminate, the thermoplastic resin layer and the hydrophilic polymer layer are laminated directly or with a photocurable adhesive layer disposed therebetween. In this laminate, the thermoplastic resin layer and the hydrophilic polymer layer are integrated.

The thermoplastic resin layer used for preparation of the stretched laminate may be preliminarily stretched prior to application of an aqueous hydrophilic polymer solution. The stretching may be uniaxial stretching, biaxial stretching, or orthogonal stretching. The uniaxial stretching may be longitudinal stretching that stretches the thermoplastic resin layer in the machine direction (MD) or lateral stretching that stretches the layer in the transverse direction (TD). In the lateral stretching, the layer can be stretched in the transverse direction while being shrunk in the machine direction.

Examples of the lateral stretching include fixed-end uniaxial stretching in which one end of the layer is fixed with a tenter and free-end uniaxial stretching in which one end is not fixed. Examples of the longitudinal stretching include interroller stretching, compression stretching, and tenter stretching. The stretching may be carried out through multiple stages. In the uniaxial stretching of the thermoplastic resin layer, longitudinal stretching (stretching in the MD) is preferred.

The thermoplastic resin layer may be stretched at any temperature, for example, in the range of preferably 130 to 200° C., more preferably 150 to 180° C. The overall draw ratio in the longitudinal and lateral directions to the original length of the thermoplastic resin layer ranges from typically 1.1 to 10, preferably 2 to 6, more preferably 3 to 5.

The aqueous hydrophilic polymer solution (also referred to as coating solution for a hydrophilic polymer layer) can be prepared by dissolving powdered hydrophilic polymer (e.g., poly(vinyl alcohol)) or a pulverized or cut product of a hydrophilic polymer film in hot or heated water. Examples of application of an aqueous hydrophilic polymer solution onto thermoplastic resin layer include wet processes, such as wire bar coating, reverse coating, roller coating such as gravure coating, spin coating, screen coating, fountain coating, dipping, and spraying.

After the application of the coating solution for forming hydrophilic polymer layer onto the thermoplastic resin layer, the coat is dried. The drying temperature ranges from typically 50 to 200° C., preferably 80 to 150° C. The drying time is typically in the range of about 5 to about 30 minutes.

An alternative method of making the stretched laminate of the present invention is a one-pass process that supplies a material for the thermoplastic resin layer and a material for the hydrophilic polymer layer through a die by coextrusion to form a laminate. In the coextrusion, the volumes of the material for the thermoplastic resin layer and the material for the hydrophilic polymer layer fed in the co-extruder are preferably controlled such that the thicknesses of the thermoplastic resin layer and the hydrophilic polymer layer reside within predetermined ranges.

The unstretched laminate is stretched and dyed with a dichroic substance. After the stretching treatment of the hydrophilic polymer and the dyeing treatment with the dichroic substance, the dichroic substance is absorbed onto the hydrophilic polymer layer and the laminate functions as a polarizer.

In the present invention, the hydrophilic polymer layer is formed on the thermoplastic resin layer by the method described above, and the laminate is dried, and then stretched in the TD or MD while being heated. The polarizer is thereby formed.

An exemplary method of stretching the laminate will now be described with reference to the drawings.

In the production process of the stretched laminate of the present invention, a hydrophilic polymer layer is formed onto a thermoplastic resin layer, and the laminate is heated and then stretched to produce a polarizer.

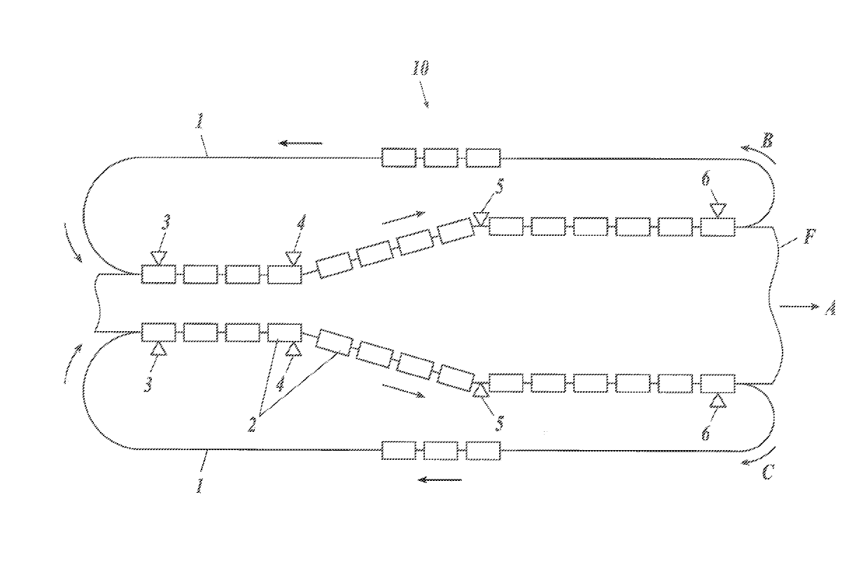

FIG. 1 is a plan view of an exemplary tenter stretching unit that stretches the laminate in the transverse direction (TD) with tenter clips in the stretching process of the present invention. The tenter stretching unit 10 holds opposite edges of the laminate F consisting of the hydrophilic polymer layer on the thermoplastic resin layer with clips 2 at a grip starting point 3, and stretches the laminate F in the transverse direction from a stretching start point 4 while transferring the laminate F in the transferring direction A. After the laminate is stretched to a predetermined width, the stretching is completed at a stretching endpoint 5, and the gripping with clips 2 is released at a grip releasing point 6 to finish the stretching step. Clips 2 are symmetrically disposed at predetermined intervals on a pair of right and left rotatable driving units (ring chains) 1 and moved in the directions of arrows B and C in the drawing. Clips 2 released at the grip releasing point 6 are moved to the grip starting point 3 to stretch the laminate continuously. The laminate in the stretching step is controlled to a predetermined temperature by a heating means (not shown in the drawing).

The travelling rate of the clips can be appropriately determined and is typically within the range of 1 to 100 m/min. The difference in the travelling rate between the right and left clips is 1% or less, preferably 0.5% or less, more preferably 0.1% or less of the travelling rate. Since a difference in the travelling rate of the film between the right and left at the exit of the stretching step causes wrinkle and slippage at the exit of the stretching step, the travelling rates of the right and left clips must be substantially identical. A common tenter has several percent unevenness in travelling rate occurring with a period of less than one second due to the cycle of the teeth of sprockets to drive the chains and the frequency of the driving motors, but does not correspond to the difference in the travelling rate.

Examples of the possible combination of the stretching unit in the present invention include:

1) preheating zone/stretching zone/retaining zone/cooling zone;

2) preheating zone/stretching zone/shrinking zone/retaining zone/cooling zone;

3) preheating zone/lateral stretching zone/longitudinal stretching zone/retaining zone/cooling zone; and

4) preheating zone/lateral stretching zone/longitudinal stretching zone/shrinking zone/retaining zone/cooling zone.

The preheating zone is a zone in which the laminate travels while the right and left clips holding the opposite edges of the laminate are maintaining a predetermined distance at the entrance of the oven.

The lateral stretching zone is a zone in which the distance between the right and left clips increases to a predetermined distance to stretch the laminate in the transverse direction (TD). The expansion angles of the right and left rails on which clips run may be the same or different.

The longitudinal stretching zone is a zone in which clips gripping the opposite edges of the laminate stretch the laminate in the travelling or machine direction (MD) while the distance between the clips are being varied.

The shrinking zone is a zone in which the distance between clips gripping the opposite edges of the laminate decrease to a predetermined distance in the direction of the stretching axis.

The retaining zone is a zone in which right and left clips travel in parallel to each other at a constant distance downstream of the lateral stretching zone or the longitudinal stretching zone.

The cooling zone is a zone in which the temperature of the zone is set to below the glass transition temperature Tg (° C.) of the thermoplastic resin of the laminate downstream of the retaining zone.

The right and left rails may have a pattern decreasing the distance between the opposite clips in view of the shrinkage of the laminate in the cooling zone.

It is preferred that the temperature of each zone to the glass transition temperature Tg of the thermoplastic resin layer be within the range of Tg to Tg+30° C. in the preheating zone, Tg to Tg+30° C. in the stretching zone, and Tg−30 to Tg° C. in the cooling zone.

In order to reduce the uneven thickness in the transverse direction, the stretching zone may have a temperature gradient in the transverse direction. The temperature gradient in the transverse direction in the stretching zone may be achieved by, for example, different degrees of openings of nozzles feeding hot wind into a temperature controlled chamber in the transverse direction, or control of heating with heaters arrayed in the transverse direction.

An example measure for preventing wrinkle or slippage of the stretched laminate involves maintaining the bearing properties of the laminate, stretching the laminate while keeping 5 volume % or more volatile content, and then shrinking the laminate while decreasing the volatile content. The term “maintaining the bearing properties of the laminate” in the present invention indicates gripping the opposite edges without deterioration of the properties of film of the laminate. The volatile content may be 5 vol % or more during the overall stretching step or may be 5 vol % or more during part of the stretching step. In the latter case, it is preferred that the volatile content be 12 vol % or more in at least 50% of the overall stretching zone from the entrance. In any way, it is preferred that the state of a volatile content of 12 vol % or more is present before the stretching. The volatile content (vol %) represents the volume of the volatile content for the unit volume of the film, i.e., (the volume of the volatile component)/(the volume of the film).

The guide roller nearest the entrance of the tenter is a driven roller that is supported by a bearing unit and guides the travel of the laminate. The roller may be composed of any material, and preferably coated with a ceramic coating to prevent scratching of the laminate. The roller may be composed of a lightweight metal such as aluminum plated with chromium to reduce the weight of the roller. The roller is provided to stabilize the trajectory of the travelling laminate.

One of the rollers upstream of the above-described roller is preferably brought into contact with a rubber roller to nip the laminate. The nip roller can reduce the variation in supply tension in the traveling direction of the laminate.

The method of making the polarizing plate of the present invention is characterized by applying a hydrophilic polymer coating solution onto the thermoplastic resin layer to form a hydrophilic polymer layer, stretching the laminate composed of the thermoplastic resin layer and the hydrophilic polymer layer in the machine direction or the transverse direction in accordance with the process described above to form a polarizer, bonding the laminate with a substrate, and detaching the thermoplastic resin layer from the laminate to prepare a polarizing plate, as described above.

<<Display Device>>

The polarizing plate of the present invention is applicable to various types of display devices, such as liquid crystal display devices and organic electroluminescent (EL) display devices.

For example, a liquid crystal display device including the polarizing plate of the present invention has superior visibility. Since the polarizing plate of the present invention has excellent rework capability, it contributes to an improvement in productivity of display devices. The polarizing plate of the present invention is applicable to liquid crystal display devices of various driving modes, such as STN, TN, OCB, HAN, VA(MVA, PVA), and IPS modes. Preferred are VA (MVA, PVA), and IPS mode liquid crystal display devices. In particular, the polarizing plate is preferably incorporated into an IPS mode liquid crystal display device.

The liquid crystal layer in the liquid crystal panel of the IPS mode liquid crystal display device has a homogenous alignment parallel to the substrate plane in an initial condition. In addition, the director of the liquid crystal layer in a plane parallel to the substrate is parallel to or slightly tilted from the direction of the electrode line while no voltage is being applied and shifts to a direction perpendicular to the electrode line when a voltage is applied. When the director of the liquid crystal layer is tilted by 450 toward the electrode line from the director during no voltage being applied, the liquid crystal layer during application of voltage rotates the azimuth angle of the polarized light by 90° as if it were a half-wavelength plate. As a result, the transmission axis of the polarizing plate at the light emerging side coincides with the azimuth angle of the polarization, resulting in a white display mode.

Although the liquid crystal layer generally has a uniform thickness, due to the horizontal electric field drive, slight unevenness of the thickness of the liquid crystal layer may increase the response rate to in-plane switching. The liquid crystal display device demonstrates its abilities to the fullest if the liquid crystal layer has an uneven thickness and thus is less affected by a variation in the thickness of the liquid crystal layer. The thickness of the liquid crystal layer ranges from 2 to 6 μm, preferably 3 to 5.5 μm. The liquid crystal display device of the present embodiment is suitably applicable to large-scale liquid crystal television sets, as well as mobile devices such as tablet display devices and smartphones.

In the present invention, the IPS mode liquid crystal cell may have any specification on known technical matter, for example, the description disclosed in Japanese Patent Application Laid Open Publication No. 2010-3060.

### EXAMPLES

It will be appreciated that the following description is intended to refer to specific examples and is not intended to define or limit the disclosure. Throughout the examples, the symbol “%” is meant by “mass %” unless otherwise stated.

### Example 1

### Preparation of Substrate

[Preparation of Substrate 1]

(1) Preparation of Dope Composition 1

Additives (a) to (f) were placed into an airtight container, were heated with agitation to be completely dissolved. The solution was filtered through a filter paper No. 24 made by Azumi Filter Paper Co., Ltd. to prepare Dope Composition 1.

(a) Cellulose ester CE-1 (see below)

90 parts by mass

(b) Plasticizer: Polyester compound A (see below)

10 parts by mass

(c) UV absorbent: Tinuvin 928 (available from Ciba Japan)

2.5 parts by mass

(d) Microparticle dispersion: Silicon dioxide dispersion (see below)

4 parts by mass

(e) Good solvent: methylene chloride

432 parts by mass

(f) Poor solvent: ethanol

38 parts by mass

<Preparation of Cellulose Ester CE-1>

To 100 parts by mass of cellulose (from cotton linter) was added 16 parts by mass of sulfuric acid, 260 parts by mass of acetic anhydride, and 420 parts by mass of acetic acid, and the mixture was heated with stirring from room temperature to 60° C. over 60 minutes and was maintained at the temperature for 15 minutes for acetylation reaction.

A solution of magnesium acetate and calcium acetate in an acetic acid and water mixture was added to neutralize sulfuric acid, and water steam was introduced into the reaction system to keep the system at 60° C. for 120 minutes for saponification aging.

The product was washed with a large volume of water and then was dried to give a Cellulose Ester CE-1.

Cellulose Ester CE-1 had a degree of acetyl substitution of 2.9 and a weight average molecular weight Mw of 270000.

<Preparation of Silicon Dioxide Dispersion>

A mixture of 10 parts by mass of Aerosil R812 (available from Nippon Aerosil Co., Ltd., mean diameter of primary particles: 7 nm) and 90 parts by mass of ethanol were agitated for 30 minutes in a dissolver and then was dispersed with a Manton Gaulin high-pressure homogenizer. Into the homogenizer, 88 parts by mass of methylene chloride was placed with agitation, and the system was mixed with agitation for 30 minutes. The liquid mixture was filtered through a diluted microparticle dispersion strainer with a polypropylene wound cartridge filter TCW-PPS-1N (made by Toyo Roshi Kaishs) to prepare a silicon dioxide dispersion.

<Synthesis of Polyester Compound A>

Into a 2-L four neck round-bottom flask with a thermometer, stirrer, a slow cooling tube, and a rapid cooling tube was placed 251 g of 1,2 propylene glycol, 278 g of phthalic anhydride, 91 g of adipic acid, 610 g of benzoic acid, and 0.191 g of tetraisopropyl titanate as an esterification catalyst, and the mixture was gradually heated with stirring in a nitrogen stream to 230° C.

After dehydrated condensation reaction for 15 hours, unreacted 1,2-propylene glycol was distilled out at 200° C. under reduced pressure to yield Polyester compound A. Polyester compound A had an acid value of 0.10 and a number averaged molecular weight of 450.

(2) Casting, Drying, and Detaching Dope

Dope composition 1 was uniformly cast onto an endless stainless-steel belt support (at 35° C.) with a belt casting apparatus. The composition was dried on the stainless-steel belt support and was separated from the stainless-steel belt support when the residual solvent content reached 100 mass %.

(3) Stretching, Drying, and Thermal Fixation

The separated web was fixed with gripers of a tenter, and was stretched at 160° C. into a draw ratio of 1.01 (1%) in the transverse direction (TD), and was kept for several seconds while the width was being maintained (thermal fixation). After the transverse tension was relaxed, the web was released from the grippers and was transferred to be dried for 30 minutes in a third drying zone at 125° C. The residual solvent at the start of stretching was 30 mass %.

(4) Winding Film

The cellulose ester film was slit into a width of 1.50 m and knurls with a width of 15 mm and a height of 10 μm were formed at both edges of the film. The film was wound around a core to prepare Substrate 1. Substrate 1 had a residual solvent content of 0.2 mass %, a thickness of 60 μm, and a length of 3000 m.

[Preparation of Substrate 2]

Substrate 2 having a thickness of 23 μm was prepared as in preparation of Substrate 1, except that the volume of Dope composition 1 cast onto the stainless steel belt support was adjusted such that the finished thickness was 23 μm.

[Preparation of Substrate 3]

Substrate 3 having a thickness of 18 μm was prepared as in preparation of Substrate 1, except that the volume of Dope composition 1 cast onto the stainless steel belt support was adjusted such that the finished thickness was 18 μm.

[Preparation of Substrate 4]

Substrate 4 having a thickness of 12 μm was prepared as in preparation of Substrate 1, except that the volume of Dope composition 1 cast onto the stainless steel belt support was adjusted such that the finished thickness was 12 μm.

[Preparation of Substrate 5]

A homopolypropylene (PP) film with a thickness 100 μm was formed by melt extrusion at 250° C. and was stretched into the transverse direction (TD) with a stretcher to give Substrate 5 having a thickness of 23 μm.

[Preparation of Substrate 6]

Substrate 6 was a commercially available biaxially stretched polyethylene terephthalate film (merely represented by PET in Table 1) with a thickness of 23 μm.

<<Preparation of Polarizing Plate Substrate>>

Polarizing plate substrates (Substrates with hard coat layers) 1 to 11 were prepared in accordance with procedures described below.

[Preparation of Polarizing Plate Substrate 1]

Coating solution 1 for a hard coat layer having a composition described below that was prepared by filtration through a polypropylene filter having a pore diameter of 0.4 μm was applied onto Substrate 1 prepared as above with a dye coater, was dried at 70° C., and was irradiated with active rays in a dose of 0.3 J/cm² at an illuminance of 300 mW/cm² at the irradiated portion with an UV lamp under nitrogen purge in an oxygen level of 1.0 vol % or less to cure the hard coat layer. The layer was further heated at 130° C. for 5 minutes under a transfer tension of 300 N/m in a heating zone into a dried thickness of 3.0 μm to give Polarizing plate substrate 1, which was then rolled up.

(Preparation of Coating Solution 1 for Hard Coat Layer)

The following components were mixed with agitation to prepare Coating solution 1 for the hard coat layer.

| | |
|---|---|
| Pentaerythritol triacrylate | 20.0 parts by mass |
| Pentaerythritol tetraacrylate | 50.0 parts by mass |
| Dipentaerythritol hexaacrylate | 30.0 parts by mass |
| Dipentaerythritol pentaacrylate | 30.0 parts by mass |
| Irgacure 184 (available from Ciba Japan) | 5.0 parts by mass |
| Fluorinated siloxane graft polymer I (35 mass %, | 5.0 parts by mass |
| see below) | |
| Seahostar KEP-50 (fine silica particle, mean | 24.3 parts by mass |
| diameter: 0.47 to 0.61 μm, available | |
| from Nippon Shokubai Co., Ltd.) | |
| Propylene glycol monomethyl ether | 20 parts by mass |
| Methyl acetate | 40 parts by mass |
| Methyl ethyl ketone | 60 parts by mass |

The commercial names of the material used in preparation of Fluorinated siloxane graft polymer I are as follows:

1) Radical Polymerizable Fluorinated Resin (A) The synthetic procedure of Radical polymerizable fluorinated resin (A) was as follows.

Into a glass reactor provided with a mechanical agitator, a thermometer, a condenser, and a dry nitrogen gas inlet was placed 1554 parts by mass of Cefral coat CF-803 (hydroxy value: 60, number average molecular weight: 15,000; available from Central glass Co., Ltd.), 233 parts by mass of xylene, and 6.3 parts by mass of 2-isocyanatoethyl methacrylate, and the reactor was heated to 80° C. under a dry nitrogen atmosphere. The mixture was reacted at 80° C. for 2 hours. After the absorption attributed to isocyanate groups disappeared in an IR spectrum of a sampled product, the reaction mixture was recovered. Radical polymerizable fluorinated resin (A) (50 mass %) having urethane bonds was prepared.

2) Single end radical polymerizable polysiloxane (B): Silaplain FM-0721 (Number average molecular weight: 5,000; available from Chisso Corporation) 3) Radical polymerization initiator: Perbutyl 0 (t-butylperoxy2-ethyl hexanoate; available from NOF Corporation)

<Preparation of Fluorinated Siloxane Graft Polymer I>

Into a glass reactor provided with a mechanical agitator, a thermometer, a condenser, and a dry nitrogen gas inlet was placed radical polymerizable fluorinated resin (A) (26.1 parts by mass) synthesized as above, xylene (19.5 parts by mass), n-butyl acetate (16.3 parts by mass), methyl methacrylate (2.4 parts by mass), n-butylmethacrylate (1.8 parts by mass), lauryl methacrylate (1.8 parts by mass), 2-hydroxyethyl methacrylate (1.8 parts by mass), single end radical polymerizable polysiloxane (B): FM-0721 (5.2 parts by mass), and radical polymerization initiator: Perbutyl 0 (0.1 parts by mass), and the reactor was heated to 90° C. under a dry nitrogen atmosphere. The mixture was reacted at 90° C. for 2 hours. Perbutyl 0 (0.1 parts by mass) was further added, and the mixture was maintained at 90° C. for 5 hours to give a solution of 35 mass % Fluorinated siloxane graft polymer I having a weight average molecular weight of 171,000. The weight average molecular weight was determined by GPC. The content (mass %) of Fluorinated siloxane graft polymer I was determined by high-performance liquid chromatography (HPLC).

[Preparation of Polarizing Plate Substrates 2 to 5]

Polarizing plate substrates 2 to 5 were prepared as in Polarizing plate substrate 1 except that the type of the substrate and the thickness of the hard coat layer were varied as described in Table 1.

[Preparation of Polarizing Plate Substrate 6]

Polarizing plate substrate 6 was prepared as in Polarizing plate substrate 1 except that Substrate 5 was used and the surface of the substrate was corona-treated immediately before a hard coat layer was applied.

[Preparation of Polarizing Plate Substrate 7]

Polarizing plate substrate 7 was prepared as in Polarizing plate substrate 2 except that Coating solution 2 for a hard coat layer described below was used instead of Coating solution 1 for a hard coat layer and was applied such that the thickness of the dried hard coat layer was 4.0 μm.

(Preparation of Coating Solution 2 for Hard Coat Layer)

The following components were mixed with agitation to prepare Coating solution 2 for a hard coat layer.

| | |
|---|---|
| Mixture of pentaerythritol triacrylate (PETA), | 100 parts by mass |
| dipentaerythritol hexaacrylate (DPHA), and | |
| poly(methylmethacrylate) (PMMA) (mass ratio of | |
| PETA/DPHA/PMMA = 86/5/9) | |
| Highly crosslinked polystyrene microparticles | 12.0 parts by mass |
| (refractive index: 1.59, average diameter: | |
| 4.0 μm) | |
| Talc particles (refractive index: 1.57, | 20.0 parts by mass |
| average diameter D50; 0.8 μm) | |
| Mixture of toluene and methyl isobutyl ketone | 190 parts by mass |
| (mass ratio: 8:2) | |

[Preparation of Polarizing Plate Substrate 8]

Polarizing plate substrate 8 was prepared and rolled up as in Preparation of Polarizing plate substrate 2 except that Coating solution 3 for a hard coat layer was used instead of Coating solution 1 for a hard coat layer and applied such that the dried hard coat layer had a thickness of 4.8 μm.

(Preparation of Coating Solution 3 for Hard Coat Layer)

The following components were mixed with agitation to prepare Coating solution 3 for a hard coat layer.

| | |
|---|---|
| Pentaerythritol triacrylate | 20.0 parts by mass |
| Pentaerythritol tetraacrylate | 40.0 parts by mass |
| Dipentaerythritol hexaacrylate | 40.0 parts by mass |
| Dipentaerythritol pentaacrylate | 20.0 parts by mass |
| Irgacure 184 (available from Ciba Japan) | 5.0 parts by mass |
| UV absorber: Tinuvin 928 (available from Ciba | 7.0 parts by mass |
| Japan) | |
| Fluorinated siloxane graft polymer I (35 mass %, | 5.0 parts by mass |
| as described above) | |
| Seahostar KEP-50 (fine silica particles, average | 24.3 parts by mass |
| diameter: 0.47 to 0.61 μm, available from Nippon | |
| Shokubai Co., Ltd.) | |
| Propylene glycol monomethyl ether | 20 parts by mass |
| Methyl acetate | 40 parts by mass |
| Methyl ethyl ketone | 60 parts by mass |

[Preparation of Polarizing Plate Substrate 9]

Polarizing plate substrate 9 was prepared as in Preparation of Polarizing plate substrate 2, except that Substrate 2 (cellulose ester) was replaced with Substrate 6 (PET).

[Preparation of Polarizing Plate Substrate 10]

Polarizing plate substrate 10 was prepared as in Preparation of Polarizing plate substrate 8, except that the thickness of the hard coat layer was modified to 2.5 μm.

[Preparation of Polarizing Plate Substrate 11]

Polarizing plate substrate 11 was prepared as in Preparation of Polarizing plate substrate 2, except that the thickness of the hard coat layer was modified to 1.2 μm.

[Measurement of Tensile Strength and Elongation at Break and Calculation of T Value]

With each of Polarizing plate substrates 1 to 11, which were the substrates with hard coat layers prepared as described above, the tensile strength and elongation at break were measured and the T value (N/10 mm) was calculated. The results are shown in Table 1.

Each polarizing plate substrate was cut into a test piece with a width of 10 mm and a length of 130 mm. The sample was stretched at a drawing rate of 100 mm/min and an interchuck distance of 50 mm with a tensile tester, Tensilon RTC-1225 (made by Orientech Co., Ltd.) at a temperature of 23° C. and a relative humidity of 55% in the machine direction (MD) and the transverse direction (TD) orthogonal to the machine direction in accordance with JIS K 7127 to determine the tensile strength and the elongation at break in each direction. From the averages of the tensile strengths and the elongations at break in the TD and MD, the T value was calculated according to the following expression:

T value (N/10 mm)=tensile strength×(elongation at break)^{1/2}

TABLE 1

| | SUBSTRATE | | | | HARD COAT LAYER | | |
|---|---|---|---|---|---|---|---|
| SUBSTRATE NO. FOR | | | THICKNESS | CORONA | COATING | THICKNESS | T VALUE |
| POLARIZING PLATE | NUMBER | MATERIAL | (μm) | TREATMENT | SOLUTION NO. | (μm) | (N/10 mm) |
| 1 | 1 | CE | 60 | UNTREATED | 1 | 3.0 | 24 |
| 2 | 2 | CE | 23 | UNTREATED | 1 | 3.0 | 16 |
| 3 | 3 | CE | 18 | UNTREATED | 1 | 3.0 | 11 |
| 4 | 4 | CE | 12 | UNTREATED | 1 | 3.0 | 8 |
| 5 | 2 | CE | 23 | UNTREATED | 1 | 7.0 | 19 |
| 6 | 5 | PP | 23 | TREATED | 1 | 3.0 | 33 |
| 7 | 2 | CE | 23 | UNTREATED | 2 | 4.0 | 10 |
| 8 | 2 | CE | 23 | UNTREATED | 3 | 4.8 | 4 |
| 9 | 6 | PET | 23 | UNTREATED | 1 | 3.0 | 12 |
| 10 | 2 | CE | 23 | UNTREATED | 3 | 2.5 | 2.5 |
| 11 | 2 | CE | 23 | UNTREATED | 1 | 1.2 | 5 |

CE: CELLULOSE ESTER,
PP: POLYPROPYLENE,
PET: POLYETHYLENE TEREPHTHALATE

<<Preparation of Polarizing Plate>>

[Preparation of Polarizing Plate 101]

(Preparation of Polarizer 1)

A 75-μm-thick poly(vinyl alcohol) film (Vinylon Film VF-P#7500 available from Kuraray Co., Ltd.) was monoaxially oriented in a dry state in the machine direction into a draw ratio of 5.2 and then was dipped in a solution of 0.05 parts by mass of iodine and 5 parts by mass of potassium iodide in 100 parts by mass of water at a temperature of 28° C. for 60 seconds while the tension was being maintained. The film was then dipped in a solution of 7.5 parts by mass of boric acid and 6 parts by mass of potassium iodide in 100 parts by mass of water at a temperature of 73° C. for 300 seconds while the tension was being maintained, and washed with pure water at 15° C. for 10 seconds. While the tension of the washed poly(vinyl alcohol) film was being maintained, it was dried at 70° C. for 300 seconds, and its ends were cut away to prepare Polarizer 1, which was a polarizing film with a width of 1300 mm. Polarizer 1 had a thickness of 33 μm.

(Preparation of Polarizing Plate)

Polarizer 1 was bonded to Polarizing plate substrate 1 in accordance with Steps 1 to 5 to prepare Polarizing plate 101.

Step 1: Polarizing plate substrate 1 was dipped in a 2 mol/L aqueous sodium hydroxide solution at 60° C. for 90 seconds, was washed with water, and was dried to prepare saponified Polarizing plate substrate 1.

Step 2: A poly(vinyl alcohol) adhesive having a solid content of 2 mass % was applied to one side of Polarizer 1.

Step 3: The side on which the poly (vinyl alcohol) adhesive was applied in Step 2 of Polarizer 1 and the side on which no hard coat layer was formed of Polarizing plate substrate 1 processed in Step 1 were disposed so as to face each other.

Step 4: Polarizing plate substrate 1 and Polarizer 1 which were laminated in Step 3 were bonded under a pressure of 20 to 30 N/cm² and at a transfer rate of about 2 m/minute.

Step 5: The sample bonded in Step 4 was dried in a drying machine at 80° C. for 2 minutes to prepare rolled Polarizing plate 101.

[Preparation of Polarizing Plate 102]

Polarizing plate 102 was prepared as in Preparation of polarizing Plate 101, except that Polarizing plate substrate 1 was replaced with Polarizing plate substrate 2.

[Preparation of Polarizing Plate 103]

(Preparation of Stretched Laminate 1 having Polarizer 2)

<Preparation of Laminate 1>

A surface of a 120-μm-thick antistatic amorphous polyethylene terephthalate sheet was corona-treated to prepare Thermoplastic resin layer A.

Poly(vinyl alcohol) powder as a hydrophilic polymer (available from Japan VAM & POVAL, average degree of polymerization: 2500, degree of saponification: 99.0 mole % or more, commercial name: JC-25) was dissolved in hot water at 95° C. to prepare an aqueous 8 mass % poly (vinyl alcohol) solution. The resulting aqueous poly (vinyl alcohol) solution was applied onto Thermoplastic resin layer A with a lip coater, and was dried at 80° C. for 20 minutes to prepare Laminate 1 of Thermoplastic resin layer A and the poly(vinyl alcohol) hydrophilic resin layer (Polarizer 2). The hydrophilic resin layer (Polarizer 2) had a thickness of 12.0 μm.

<Stretching Process>

Laminate 1 was stretched at 160° C. by free-end uniaxial drawing into a draw ratio of 5.3 in the machine direction (MD) to prepare Stretched laminate 1. The hydrophilic resin layer (Polarizer 2) of Stretched laminate 1 had a thickness of 5.6 μm.

<Dyeing Process>

Stretched laminate 1 was dipped in a warm water bath at 60° C. for 60 seconds, and then dipped in a solution of iodine (0.05 parts by mass) and potassium iodide (5 parts by mass) in water (100 parts by mass) at 28° C. for 60 seconds. The laminate was dipped in a solution of boric acid (7.5 parts by mass) and potassium iodide (6 parts by mass) in water (100 parts by mass) at 73° C. for 300 seconds while the laminate was being tensioned, and was then washed with pure water at 15° C. for 10 seconds. The washed film was dried at 70° C. for 300 seconds while the film was being tensioned to prepare Stretched laminate 1 consisting of Thermoplastic resin layer A and Polarizer 2.

(Preparation of Polarizing Plate)

Stretched laminate 1 prepared as above was bonded to Polarizing plate substrate 1 prepared as above, and then Thermoplastic resin layer A was removed in accordance with Steps 1 to 6 to prepare Polarizing plate 103.

Step 1: Polarizing plate substrate 1 was dipped in a 2 mol/L sodium hydroxide solution at 60° C. for 90 seconds, was washed with water, and then dried to prepare Polarizing plate substrate 1 of which a side to be bonded to a polarizer was saponified.

Step 2: A poly(vinyl alcohol) adhesive having a solid content of 2 mass % was applied onto a side provided with Polarizer 2 of Stretched laminate 1.

Step 3: The side (side of Polarizer 2) on which the poly (vinyl alcohol) adhesive was applied in Step 2 and the side on which no hard coat layer was formed of Polarizing plate substrate 1 were disposed so as to face each other.

Step 4: The sample laminated in Step 3 was bonded under a pressure of 20 to 30 N/cm² and at a transfer rate of about 2 m/minute.

Step 5: The sample bonded in Step 4 was dried in a drying machine at 80° C. for 2 minutes to prepare a polarizing plate consisting of Polarizing plate substrate 1, Polarizer 2, and Thermoplastic resin layer A.

Step 6: Thermoplastic resin layer A was detached from the resulting polarizing plate. Thermoplastic resin layer A was readily detached into rolled Polarizing plate 103.

[Preparation of Polarizing Plates 104 to 106 and 108 to 114]

Polarizing plates 104 to 106 and 108 to 114 were prepared as in Preparation of Polarizing plate 103 except that the polarizing plate substrates described in Table 2 were used.

[Preparation of Polarizing Plate 107]

Polarizing plate 107 was prepared as in preparation of Polarizing plate 106 except that Polarizer 2 was replaced with polarizer 3 prepared by the following method.

(Preparation of Polarizer 3)

<Preparation of Thermoplastic resin Layer B>

The following film was prepared as Thermoplastic resin layer B.

The following components were mixed in a vacuum Nauta mixer at 80° C. under 133 Pa for 3 hours, and were dried. The resulting mixture was melt-extruded through a biaxial extruder at 235° C. to pelletize the mixture.

| | |
|---|---|
| Acrylic resin (methyl methacrylate/acroylmorpholine = | 70 parts by mass |
| 80/20 (mole ratio); Mw = 100000; dried at 90° C. for 3 hours into | |
| a moisture content of 1000 ppm) | |
| Cellulose ester resin (cellulose acetate propionate: | 30 parts by mass |
| total degree of acyl substitution: 2.7, degree of acetyl | |
| substitution: 0.1, degree of propionyl substitution: 2.6, Mw = | |
| 200000, dried at 100° C. for 3 hours into a moisture content | |
| of 500 ppm) | |
| Tinuvin 928 (available from BASF Japan) | 1.1 parts by mass |
| Adekastab PEP-36 (available from ADEKA Corporation) | 0.25 parts by mass |
| Irganox 1010 (available from BASF Japan) | 0.5 parts by mass |
| Sumilizer GS (Sumitomo Chemical Co., Ltd.) | 0.24 parts by mass |
| Aerosil R972V (available from Nippon Aerosil Co., Ltd.,) | 0.27 parts by mass |

The resulting pellets were dried in a circulated dried air at 70° C. for 5 hours or more and were introduced into a monoaxial extruder in the next stage while maintaining the temperature at 100° C.

The pellets melt at a temperature of 240° C. were extruded from a T die of a uniaxial extruder onto a first cooling roller at 90° C. into a 120-μm-thick Thermoplastic resin layer B during which the film was pressed on the first cooling roller with an elastic touch roller having a metal surface with a thickness of 2 mm.

<Preparation of Laminate 2>

Poly(vinyl alcohol) powder as hydrophilic polymer (available from Japan VAM & POVAL, average degree of polymerization: 2500, degree of saponification: 99.0 mole % or more, commercial name: JC-25) was dissolved in hot water at 95° C. to prepare an aqueous 8 mass % poly (vinyl alcohol) solution. The resulting aqueous solution was applied onto Thermoplastic resin layer B with a lip coater, was dried at 80° C. for 20 minutes to prepare Laminate 2 consisting of Thermoplastic resin layer B and the hydrophilic resin layer (Polarizer 3). The hydrophilic resin layer (Polarizer 3) had a thickness of 12.5 μm.

<Stretching Process>

Laminate 2 was stretched at 145° C. by free-end uniaxial drawing into a draw ratio of 5.3 in the machine direction (MD) to prepare Stretched laminate 2. The hydrophilic resin layer (Polarizer 3) of Stretched laminate 2 had a thickness of 5.2 μm.

<Dyeing Process)

Stretched laminate 2 was dipped in a warm water bath at 60° C. for 60 seconds, and then dipped in a solution of iodine (0.05 parts by mass) and potassium iodide (5 parts by mass) in water (100 parts by mass) at 28° C. for 60 seconds. The laminate was dipped in a solution of boric acid (7.5 parts by mass) and potassium iodide (6 parts by mass) in water (100 parts by mass) at 73° C. for 300 seconds while the laminate was being tensioned, and was then washed with pure water at 15° C. for 10 seconds. The washed film was dried at 70° C. for 300 seconds while the film was being tensioned to prepare Stretched laminate 2 consisting of Thermoplastic resin layer B and Polarizer 3.

[Preparation of Polarizing plates 115 to 118]

Polarizing plates 115 to 118 were prepared as in Preparation of Polarizing plate 106, except that the thickness of the polarizer (aqueous polymer layer) was varied as described in Table 2.

<<Evaluation of Polarizing Plate>>

Each polarizing plate prepared as above was evaluated for the following items.

(Evaluation of Curling)

Rolled polarizing plates 101 to 118 were each unwound and cut into a sample with dimensions of 50 mm (transverse direction)×30 mm (longitudinal direction) in the substantial center, and the sample was left on a horizontal board at 23° C. and a relative humidity of 80% for 24 hours. Curling of the polarizing plate was visually observed and evaluated in accordance with the following criteria:

⊚: Substantially flat without curling

◯: Slight curling at four corners within a practical range

Δ: Distinct curling unsuitable for handling

X: Severe curling precluding handling

(Evaluation Durability 1: Resistance to Polarization Unevenness after High-Temperature, High-Humid Treatment in Rolled State)

The rolled polarizing plate was left in a high-temperature and high-humidity environment at a temperature of 60° C. and a relative humidity of 90% for one week. The degree of polarization C of the outermost periphery portion of the polarizing plate was measured at each of a 25% position, a 50% position (center), and a 75% position from an edge in the transverse direction. The same measurement was repeated every 10 m toward the core in the longitudinal direction to determine the degree of polarization at 150 points over 500 m from the outer portion to the inner portion. The variation (%) in the degree of polarization C throughout all the points was determined as a differential degree of polarization 1.

The as-produced or untreated rolled polarizing plate was also similarly evaluated and the variation (%) in the degree of polarization C throughout all the points was determined as a differential degree of polarization 2. The difference between the degrees of polarizations 1 and 2 (polarization 1-polarization 2) was calculated as an increment in the variation in the degree of polarization due to a high-temperature and high-humidity environment (ΔPolarization 1). Durability 1 as a measure of polarization unevenness due to high-temperature, high-humid treatment was evaluated using ΔPolarization 1 in accordance with the following criteria.

The degree of polarization C was measured with an automatic polarized film measuring device VAP-7070 (made by JASCO Corporation) and dedicated programs.

⊚: ΔPolarization 1<1.0%

◯: 1.0%<ΔPolarization 1<2.0%

Δ: 2.0%<ΔPolarization 1<5.0%

X: 5.0%<ΔPolarization 1

(Evaluation of Durability 2: Resistance to Polarization Unevenness after High-Temperature, High-Humid Treatment in State Bonded to Glass)

The rolled polarizing plate was unwound and was cut into a size of a 42-inch liquid crystal panel (930 mm×520 mm) in the substantial center at 500 m from the outer periphery. The cut samples was left in an environment at a temperature of 23° C. and a relative humidity of 55% for 24 hours. The cut polarizing plate was bonded at four corners to a side of a glass plate (thickness of 1.2 mm) that was preliminarily washed with ethanol with a 25 μm double-sided adhesive tape (substrate-free tape MO-3005C made by Lintec Corporation) such that the side of the polarizer of the polarizing plat faces the glass. The polarizing plate bonded to the glass plate was prepared.

The polarizing plate bonded to the glass plate was left at an environment at a temperature of 60° C. and a relative humidity of 90% for 300 hours, and the polarizing plate was detached from the glass plate. The variation (%) in the degree of polarization was measured as a differential degree of polarization C at the orthogonal center (ρ0) and the 75% point (ρ75) from the orthogonal center of the polarizing plate. The difference between the degrees of polarizations was calculated as an increment in the variation in the degree of polarization (ΔPolarization 2). Durability 2 as a measure of polarization unevenness after the high-temperature, high-humidity environment in the glass bonded state was evaluated using ΔPolarization 2 in accordance with the following criteria.

The degree of polarization was measured with an automatic polarized film measuring device VAP-7070 (made by JASCO Corporation) and dedicated programs.

Differential variation (%) in degree of polarization (ΔPolarization 2)=variation (%) in degree of polarization at 75% point (ρ75)−variation (%) in degree of polarization at orthogonal center (ρ0) of polarizing plate

⊚: ΔPolarity 2<1.0%

◯: 1.0%<ΔPolarity 2<2.0%

Δ: 2.0%<ΔPolarity 2<5.0%

X: 5.0%<ΔPolarity 2

The results are shown in Table 2.

TABLE 2

| | | | | | | | | | DURABILITY 2 | |
|---|---|---|---|---|---|---|---|---|---|---|
| | | | | | | | | DURABILITY 1 | RESISTANCE | |
| | SUBSTRATE | | POLARIZER | | | TOTAL | | RESISTANCE | TO | |
| | FOR | | (AQUEOUS | | | THICKNESS | | TO | POLARIZATION | |
| | POLARIZING | | POLYMER LAYER) | | | OF | | POLARIZATION | UNEVENNESS | |
| POLAR- | PLATE | | | | THICK- | POLARIZING | | UNEVENNESS | AFTER | |
| IZING | | T VALUE | | DRAW | NESS | PLATE | | AT ROLLED | BONDED TO | |
| PLATE NO. | NO. | (N/10 mm) | NO. | RATIO | (μm) | (μm) | CURLING | STATE | GLASS | REMARKS |
| 101 | 1 | 24 | 1 | 5.2 | 33.0 | 96.0 | Δ | Δ | Δ | COMPARATIVE |
| | | | | | | | | | | EXAMPLE |
| 102 | 2 | 16 | 1 | 5.2 | 33.0 | 59.0 | X | X | Δ | COMPARATIVE |
| | | | | | | | | | | EXAMPLE |
| 103 | 1 | 24 | 2 | 5.3 | 5.6 | 68.6 | Δ | Δ | X | COMPARATIVE |
| | | | | | | | | | | EXAMPLE |
| 104 | 5 | 19 | 2 | 5.3 | 5.6 | 35.6 | X | X | Δ | COMPARATIVE |
| | | | | | | | | | | EXAMPLE |
| 105 | 6 | 33 | 2 | 5.3 | 5.6 | 31.6 | X | X | X | COMPARATIVE |
| | | | | | | | | | | EXAMPLE |
| 106 | 2 | 16 | 2 | 5.3 | 5.6 | 31.6 | ◯ | ◯ | ◯ | PRESENT |
| | | | | | | | | | | INVENTION |
| 107 | 2 | 16 | 3 | 5.3 | 5.2 | 31.2 | ◯ | ⊚ | ◯ | PRESENT |
| | | | | | | | | | | INVENTION |
| 108 | 3 | 11 | 2 | 5.3 | 5.6 | 26.6 | ⊚ | ◯ | ◯ | PRESENT |
| | | | | | | | | | | INVENTION |
| 109 | 4 | 8 | 2 | 5.3 | 5.6 | 20.6 | ⊚ | ◯ | ⊚ | PRESENT |
| | | | | | | | | | | INVENTION |
| 110 | 7 | 10 | 2 | 5.3 | 5.6 | 38.6 | ⊚ | ◯ | ◯ | PRESENT |
| | | | | | | | | | | INVENTION |
| 111 | 8 | 4 | 2 | 5.3 | 5.6 | 33.4 | ◯ | ⊚ | ◯ | PRESENT |
| | | | | | | | | | | INVENTION |
| 112 | 9 | 12 | 2 | 5.3 | 5.6 | 31.6 | ◯ | ◯ | ◯ | PRESENT |
| | | | | | | | | | | INVENTION |
| 113 | 10 | 2.5 | 2 | 5.3 | 5.6 | 31.1 | Δ | ◯ | X | COMPARATIVE |
| | | | | | | | | | | EXAMPLE |
| 114 | 11 | 5 | 2 | 5.3 | 5.6 | 29.8 | ◯ | ◯ | ◯ | PRESENT |
| | | | | | | | | | | INVENTION |
| 115 | 2 | 16 | 2 | 5.3 | 0.4 | 26.4 | X | Δ | X | COMPARATIVE |
| | | | | | | | | | | EXAMPLE |
| 116 | 2 | 16 | 2 | 5.3 | 0.7 | 26.7 | ◯ | ◯ | ◯ | PRESENT |
| | | | | | | | | | | INVENTION |
| 117 | 2 | 16 | 2 | 5.3 | 9.0 | 35.0 | ◯ | ◯ | ◯ | PRESENT |
| | | | | | | | | | | INVENTION |
| 118 | 2 | 16 | 2 | 5.3 | 12.0 | 38.0 | Δ | Δ | X | COMPARATIVE |
| | | | | | | | | | | EXAMPLE |

The results shown in Table 2 demonstrate that the polarizing plate having a configuration defined by the present invention contributes to thinning of the polarizer compared to Comparative Example. As a result, the polarizing plate has superior curling resistance, high resistance to polarization unevenness after high-temperature, high-humidity preservation at a rolled state, and high resistance to a variation in the degree of polarization after preservation in a high-temperature, high-humidity environment after being bonded to the glass plate.

### Example 2

### Preparation of Liquid Crystal Display Device

The liquid crystal panel unit was detached from a liquid crystal display device including an in-plain switching mode (IPS mode) liquid crystal cell “REGIA 47ZG2 made by Toshiba Corporation”, and two polarization plates were removed from two sides of the liquid crystal cell. The front and back surfaces of the glasses of the liquid crystal cell were washed.

Each polarizing plate prepared in Example 1 was bonded to both face of the liquid crystal cell with an acrylic adhesive (20 μm thick) such that each polarizer faces the liquid crystal panel, that the slow axis of the protective film of the upper (viewer side) circularly polarizing plate was parallel to (0±0.2 degrees) a long side of the liquid crystal cell, and that the slow axis of the protective film of the lower (backlight side) circularly polarizing plate was parallel to (0±0.2 degrees) a short side of the liquid crystal cell.

Liquid crystal display devices 201 to 218 were produced as described above.

<<Evaluation of Liquid Crystal Display Device>>

Each liquid crystal display device was evaluated for the following items.

(Measurement of Contrast Ratio)

The contrast ratio of the liquid crystal display device was determined in accordance with the following procedure.

A white image and a black image were displayed on the liquid crystal display device, the Y value in the XYZ display system at an azimuth angle of 45° and a polar angle of 60° with an EZ Contrast 160D made by ELDIM. The orthogonal contrast ratio “YW/YB” was calculated from the Y value in the white image (YW) and the Y value in the black image (YB). The azimuth angle of 45° indicates the orientation counterclockwise rotated by 45° from the long side)(0° of the panel, and the polar angle of 60° indicates the direction tilted by 60° from the front direction θ° of the display screen. The measurement was carried out in a dark room at a temperature of 23° C. and a relative humidity of 55%. A higher value, which is preferred, indicates a higher contrast.

[Evaluation of Resistance to Corner Unevenness]

Each liquid crystal display device used for the measurement of the contrast ratio was left in an environment of a temperature of 60° C. and a relative humidity of 90% for 1500 hours and conditioned in an environment of a temperature of 25° C. and a relative humidity of 60% for 20 hours. The back light was turned on to observe leakage of light at peripheries of the black image, and the resistance to the corner unevenness was evaluated in accordance with the following criteria.

⊚: No light leakage at peripheries

◯: Negligible level of light leakage at peripheries

Δ: Distinct light leakage at peripheries

X: Significant light leakage at peripheries

The results are shown in Table 3.

TABLE 3

| | | RESISTANCE | |
|---|---|---|---|
| DISPLAY | CON- | TO | |
| DEVICE | TRAST | CORNER | |
| NO. | RATIO | UNEVENNESS | REMARKS |
| 201 | 37 | Δ | COMPARATIVE EXAMPLE |
| 202 | 30 | X | COMPARATIVE EXAMPLE |
| 203 | 27 | X | COMPARATIVE EXAMPLE |
| 204 | 20 | Δ | COMPARATIVE EXAMPLE |
| 205 | 25 | X | COMPARATIVE EXAMPLE |
| 206 | 55 | ◯ | PRESENT INVENTION |
| 207 | 58 | ⊚ | PRESENT INVENTION |
| 208 | 63 | ◯ | PRESENT INVENTION |
| 209 | 51 | ⊚ | PRESENT INVENTION |
| 210 | 53 | ⊚ | PRESENT INVENTION |
| 211 | 57 | ◯ | PRESENT INVENTION |
| 212 | 52 | ◯ | PRESENT INVENTION |
| 213 | 31 | Δ | COMPARATIVE EXAMPLE |
| 214 | 50 | ◯ | PRESENT INVENTION |
| 215 | 35 | Δ | COMPARATIVE EXAMPLE |
| 216 | 50 | ◯ | PRESENT INVENTION |
| 217 | 51 | ◯ | PRESENT INVENTION |
| 218 | 39 | Δ | COMPARATIVE EXAMPLE |

The results shown in Table 3 demonstrate that the in-plain switching mode (IPS mode) liquid crystal display devices including the polarizing plates of the present invention, compared to Comparative Example, can display high-contrast images and have high resistance to corner unevenness after preservation in a high-temperature, high-humidity environment.

### INDUSTRIAL APPLICABILITY

The polarizing plate of the present invention is a thin polarizing plate having high contrast, reduced image unevenness (corner unevenness), high curling stability, and high resistance under a high-temperature, high-humidity environment, and is suitably applicable to various display devices, such as liquid crystal display devices and organic electroluminescent (EL) display devices.

### EXPLANATION OF REFERENCE NUMERALS

1 rotation driving device (chain)
2 clip
3 start position of gripping
4 start position of stretching
5 end position of the stretching
6 releasing position of gripping
10 tenter stretching device
F film

1. A polarizing plate comprising a laminate of a substrate which has a hard coat layer formed by an application process and a polarizer which includes a hydrophilic polymer layer on which a dichroic substance is adsorbed, wherein
the polarizer is formed by applying the hydrophilic polymer layer onto a thermoplastic resin layer and stretching the layers, the stretched hydrophilic polymer layer has a thickness in range of 0.5 to 10 μm, the hard coat layer has a thickness in range of 1.0 to 5.0 μm, and the substrate having the hard coat layer satisfies a condition defined by Expression (1):
3<T<18 Expression (1)
where T (N/10 mm)=A×(B)^{1/2}, A is a tensile strength (N/10 mm) determined in accordance with JIS K 7127, and B is an elongation at break determined in accordance with JIS K 7127.

2. The polarizing plate of claim 1, wherein the substrate has a thickness in range of 5.0 to 25 μm.

3. The polarizing plate of claim 1, wherein the substrate includes a cellulose ester film.

4. The polarizing plate of claim 1, wherein the thermoplastic resin layer includes a cellulose ester film or a polyethylene terephthalate film.

5. The polarizing plate of claim 1, wherein the substrate contains an ester compound being a reaction product of phthalic acid, adipic acid, benzenemonocarboxylic acid and an alkylene glycol having a carbon number of 2 to 12.

6. The polarizing plate of claim 1, wherein the hydrophilic polymer layer of the polarizer includes a coat of a polyviniyl alcohol resin.

7. The polarizing plate of claim 1, wherein the dichroic substance includes an iodine-containing compound.

8. A method for manufacturing the polarizing plate set forth in claim 1, the method comprising:
applying a hydrophilic polymer coating solution onto a thermoplastic resin layer to form a hydrophilic polymer layer;
stretching a laminate of the thermoplastic resin layer and the hydrophilic polymer layer in a longitudinal or lateral direction to produce a polarizer including the hydrophilic polymer layer;
bonding the laminate to a substrate; and
removing the thermoplastic resin layer.

9. A liquid crystal display device comprising the polarizing plate set forth in claim 1.
